(19) United States
(12) Patent Application Publication
(10) Pub. No.: US 2025/0119946 A1
(43) Pub. Date: Apr. 10, 2025

(54) CHANNEL SHARING METHOD AND DEVICE, AND READABLE STORAGE MEDIUM

(71) Applicant: VIVO MOBILE COMMUNICATION CO., LTD., Dongguan (CN)

(72) Inventors: Jianhui LI, Dongguan (CN); Qian ZHENG, Dongguan (CN); Xiao XIAO, Dongguan (CN); Zichao JI, Dongguan (CN)

(73) Assignee: VIVO MOBILE COMMUNICATION CO., LTD., Dongguan (CN)

(21) Appl. No.: 18/986,932

(22) Filed: Dec. 19, 2024

Related U.S. Application Data
(63) Continuation of application No. PCT/CN2023/100418, filed on Jun. 15, 2023.

(30) Foreign Application Priority Data
Jun. 22, 2022 (CN) 202210713606.4

(51) Int. Cl. H04W 74/0808; H04W 72/231; H04W 72/40; H04W 72/563

(52) U.S. Cl. CPC H04W 74/0808; H04W 72/231; H04W 72/40; H04W 72/563

(57) ABSTRACT

This application provides a channel sharing method and device, and a readable storage medium. The method includes: determining, by a first terminal, channel occupancy time (COT) sharing information; and transmitting, by the first terminal, the COT sharing information to one or more second terminals. The COT sharing information is used for indicating shared COT. The first terminal determines information content of the COT sharing information for indicating the shared COT, and then transmits the COT sharing information to the one or more second terminals, to implement channel sharing between terminals in an Sidelink in Unlicensed Spectrum (SL-U).

### CROSS-REFERENCE TO RELATED APPLICATIONS

This application is a continuation of International Application No. PCT/CN 2023/100418, filed on Jun. 15, 2023, which claims the priority of Chinese Patent Application No. 202210713606.4 filed on Jun. 22, 2022. The entire contents of each of the above-referenced applications are expressly incorporated herein by reference.

### TECHNICAL FIELD

This application relates to the field of communication technologies, and specifically, to a channel sharing method and device, and a readable storage medium.

### BACKGROUND

In a New Radio in Unlicensed Spectrum (NR-U), Channel Occupancy Time (COT) sharing only occurs between a base station and a User Equipment (UE), where the UE may, for example, be referred to as a terminal. To be specific, the COT sharing may be classified into uplink COT sharing (the UE shares COT with the base station) and downlink COT sharing (the base station shares COT with the UE).

However, in a Sidelink in Unlicensed Spectrum (SL-U), how to achieve a COT sharing behavior is not clear at present.

### SUMMARY

Embodiments of this application provide a channel sharing method and device, and a readable storage medium.

In a first aspect, a channel sharing method is provided, including:
determining, by a first terminal, COT sharing information, where the COT sharing information is used for indicating shared COT; and
transmitting, by the first terminal, the COT sharing information to one or more second terminals.

In a second aspect, a channel sharing method is provided, including:
receiving, by a second terminal, COT sharing information from a first terminal, where the COT sharing information is used for indicating shared COT; and
processing, by the second terminal, the COT sharing information.

In a third aspect, a channel sharing apparatus is provided, including:
a first determining module, configured to determine COT sharing information, where the COT sharing information is used for indicating shared COT; and
a first transmitting module, configured to transmit the COT sharing information to one or more second terminals.

In a fourth aspect, a channel sharing apparatus is provided, including:
a receiving module, configured to: receive COT sharing information from a first terminal, where the COT sharing information is used for indicating shared COT; and
a processing module, configured to process the COT sharing information.

In a fifth aspect, a terminal is provided. The terminal includes a processor and a memory. The memory stores a program or an instruction runnable on the processor; and the program or the instruction, when run by the processor, implements the steps of the method as described in the first aspect or the steps of the method as described in the second aspect.

In a sixth aspect, a terminal is provided. The terminal includes a processor and a communication interface. The processor is configured to determine COT sharing information. The COT sharing information is used for indicating shared COT. The communication interface is used for transmitting the COT sharing information to one or more second terminals.

Or, the communication interface is used for receiving COT sharing information from a first terminal. The COT sharing information is used for indicating shared COT. The processor is configured to process the COT sharing information.

In a seventh aspect, a readable storage medium is provided, having a program or an instruction stored thereon. The program or instruction, when run by a processor, implements the steps of the method as described in the first aspect or implement the steps of the method as described in the second aspect.

In an eighth aspect, a chip is provided. The chip includes a processor and a communication interface. The communication interface is coupled to the processor. The processor is configured to run a program or an instruction to implement the steps of the method as described in the first aspect or implement the steps of the method as described in the second aspect.

In a ninth aspect, a computer program/program product is provided. The computer program/program product is stored in a storage medium. The computer program/program product is run by at least one processor to implement the steps of the method as described in the first aspect or the steps of the method as described in the second aspect.

In a tenth aspect, a channel sharing system is provided, including: a first terminal and a second terminal. The first terminal may be configured to perform the steps of the channel sharing method as described in the first aspect or the steps of the channel sharing method as described in the second aspect.

In this embodiment of this application, the first terminal determines information content of the COT sharing information for indicating the shared COT, and then transmits the COT sharing information to the one or more second terminals, to implement channel sharing between terminals in an SL-U.

### BRIEF DESCRIPTION OF THE DRAWINGS

FIG. 1 is a block diagram of a wireless communication system according to an embodiment of this application;

FIG. 2 is a flowchart I of a channel sharing method according to an embodiment of this application;

FIG. 3a is an application example I according to an embodiment of this application;

FIG. 3b is an application example II according to an embodiment of this application;

FIG. 4 is a flowchart II of a channel sharing method according to an embodiment of this application;

FIG. 5a is a structural diagram I of a channel sharing apparatus according to an embodiment of this application;

FIG. 5b is a structural diagram II of a channel sharing apparatus according to an embodiment of this application;

FIG. 6 is a structural diagram of a communication device according to an embodiment of this application; and

FIG. 7 is a structural diagram of a terminal according to an embodiment of this application.

### DETAILED DESCRIPTION

The technical solutions in embodiments of this application are described in the following with reference to the accompanying drawings in this embodiment of this application. Apparently, the described embodiments are merely some rather than all the embodiments of this application. All other embodiments obtained by persons skilled in the art based on the embodiments of this application fall within the protection scope of this application.

This specification and claims of this application, and terms “first” and “second” are used to distinguish similar objects, but are unnecessarily used to describe a specific sequence or order. It should be understood that terms used like this are interchangeable where appropriate, so that the embodiments of this application can be implemented in an order other than those illustrated or described here. Furthermore, objects distinguished by “first”, “second”, and the like are usually of the same class and do not limit the number of objects. For example, the first object can be one or multiple. In addition, “and/or” used in this specification and the claims represents at least one of the connected objects. Symbol “/” usually represents an “or” relationship between front and back associated objects.

It is worth noting that the technology described in this embodiment of this application is not limited to a long term evolution (LTE)/LTE Evolution (LTE-Advanced (LTE-A)) system, and can be used in other wireless communication systems, such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in this embodiment of this application are often used interchangeably, and the described technology can be applied to the aforementioned systems and radio technologies, as well as other systems and radio technologies. The following describes a new radio (NR) system for the example purpose and uses the term NR in most of the following descriptions. However, in some embodiments, these technologies can be applied to applications except the NR system application, such as a 6th generation (6G) communication system.

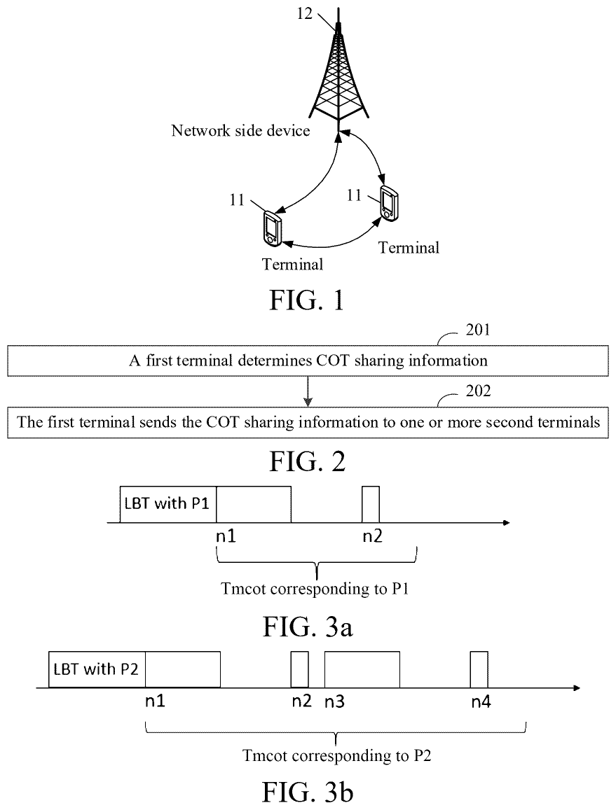

FIG. 1 shows a block diagram of a wireless communication system applicable to an embodiment of this application. The wireless communication system includes a terminal 11 and a network side device 12. The terminal 11 can be a mobile phone, a tablet personal computer, a laptop computer or also referred to as a laptop, a personal digital assistant (PDA), a handheld computer, a netbook, ultra-mobile personal computer (UMPC), a mobile internet device (MID), an augmented reality (AR)/virtual reality (VR) device, a robot, a wearable device, a vehicle user equipment (VUE), a pedestrian user equipment (PUE), a smart home (home devices with wireless communication functions, such as a refrigerator, a television, a washing machine, or furniture), a game console, a personal computer (PC), a teller machine, a vending machine, or other terminal side devices. The wearable device includes: a smart watch, a smart hand ring, a smart headphone, smart glasses, a smart jewelry (a smart bracelet, a smart ring, a smart necklace, a smart bangle, a smart anklet, and the like), a smart wristband, smart clothing, and the like. It should be noted that, in this embodiment of this application, a specific type of the terminal 11 is not limited. The network side device 12 may include an access network device or a core network device. For example, the access network device may be referred to as a radio access network device, a Radio Access Network (RAN), a radio access network function, or a radio access network unit. The access network device may include a base station, a wireless local area network (WLAN) access point, a wireless fidelity (WiFi) node, and the like. The base station can be referred to as a node B, an evolution node B (eNB), an access point, a base transceiver station (BTS), a radio base station, a radio transceiver, a basic service set (BSS), an extended service set (ESS), a home B node, a home evolution type B node, a transmitting receiving point (TRP), or any other suitable term in the art, as long as the same technical effects are achieved. The base station is not limited to a particular technical vocabulary. It should be noted, in this embodiment of this application, only the base station in the NR system is taken as an example, but a specific type of the base station is not limited.

To better understand the technical solutions of this application, the following content will be first described:

### NR-U

### Listen Before Talk (LBT) Failure

A radio resource control (RRC) configures a consistent LBT failure recovery procedure for a medium access control (MAC) entity. If LBT is performed before transmission, detecting that a channel is busy, a lower layer transmits an LBT failure indication to the MAC entity.

A Consistent LBT failure is based on per UL BWP, and is generated by counting LBT failure indications of all ULs from the lower layer to the MAC entity. A parameter used by a UE for LBT failure counting is LBT_COUNTER (per Serving Cell). The RRC configures two parameters, lbt-FailureInstanceMaxCount and lbt-FailureDetectionTimer, for Consistent LBT failure detection in lbt-FailureRecoveryConfig, where the UL represents an Uplink, and the BWP represents an uplink bandwidth part.

Each time the MAC entity receives an LBT failure indication from the lower layer, the LBT_COUNTER is plus one. When LBT_COUNTER≥lbt-FailureInstanceMaxCount, consistent LBT failure is triggered for an active UL BWP of a serving cell. Then, on the same carrier of the serving cell, the active UL BWP is switched to another UL BWP on which a physical random access channel (PRACH) occasion is configured and no consistent LBT failure is triggered (to continue to perform LBT). If the consistent LBT failure is triggered for all UL BWPs of the serving cell, the consistent LBT failure is indicated to a higher layer.

### Channel Occupancy (CO)/Channel Occupancy Time (COT

An eNB/gNB may initiate Channel Occupancy according to a downlink (DL) channel access of the nodeB itself or an UL channel access of a UE. The eNB/gNB/UE may determine maximum COT by using a channel access priority class (CAPC).

### COT Sharing

COT sharing in a downlink direction: After accessing a channel to obtain CO in a Type1 channel access manner, an eNB/gNB may instruct, by using DCI, a UE to share the CO with the eNB/gNB. This is referred to as COT sharing.

COT sharing in an uplink direction: After accessing a channel to obtain CO in a Type1 channel access manner, a UE may instruct, by using autonomous uplink-uplink control information (AUL-UCI)/configured grant-uplink control information (CG-UCI), an eNB/gNB to share the CO with the UE. This is referred to as COT sharing, too.

### Channel Access Priority Class (CAPC)

Before preempting a channel, an eNB/gNB/UE needs to determine a CAPC value, and look up a table (Table 1 below) based on the CAPC value to determine a window parameter for channel access for LBT. The CAPC value is p=1 to 4, where p=1 represents the highest priority. An LBT window corresponding to the highest priority is shorter than an LBT window corresponding to another priority. Namely, time required to successfully perform LBT by using p=1 is averagely shorter than time required for successful LBT by using p=2/3/4. However, a maximum occupable COT length is correspondingly short too, which reflects a degree of fairness in preempting a channel by different devices.

For p=3 and p=4, if it ensures, in the long term, that no other RAT shares the channel (e.g. a stipulated limitation), T_{m,cot,p}=10 ms; otherwise, T_{m,cot,p}=8 ms.

TABLE 1

| CAPC (p) | mₚ | CW_{min, p} | CW_{max, p} | T_{mcot, p} | Allowed CWₚ |
|---|---|---|---|---|---|
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, 255, 511, 1023} |

When a UE needs to transmit uplink data to perform LBT, the UE needs to determine a CAPC value of the current LBT according to a type of data to be transmitted in a manner agreed on in an agreement or configured by a network. When the data that needs to be transmitted by the UE includes data carried by a signaling radio bearer (SRB) 0/SRB1/SRB3 bearer, p=1 is always used by default. For SRB2/a data radio bearer (DRB), a network side may configure, for the UE, CAPC values for transmitting data of SRB2 and DRB bearers.

### 2. NR SL

### Quality of Service-Profile (QoS-Profile)

When an SL UE needs to perform SL transmission, the SL UE may access a network and report SidelinkUEInformationNR information to a base station. The information carries Tx resource requests of at most 32 SL destinations. The Tx resource request of each SL destination includes sl-QoS-FlowIdentities and sl-QoS-Profiles of at most 64 SL QoS flows.

The base station may then indicate, for the UE in an SDAP configuration of each radio bearer in a sidelink radio bearer (SLRB) configuration of an RRC reconfiguration message, which sl-QoS-FlowIdentities are mapped to this radio bearer.

When the SL UE is in an RRC IDLE state, the SL UE may further obtain an SLRB configuration from an SIB12 message of a resident cell, and each SLRB in the configuration has some SL quality of service (QOS) Flow mapped to this bearer and SL-QoS-Profiles of these SL QoS flows.

### Destination Selection

According to an existing NR sidelink MAC layer logical channel multiplexing technology, when a UE selects a logical channel, an MAC entity needs to first determine a destination for each serial communication interface (SCI) corresponding to new transmission. Details are as follows:

1> A destination associated with one of unitcast, group-cast, and broadcast is selected from logical channel(s) and MAC control element(s) (CE(s)) (if any) that meet all the following conditions for SL grant related to the SCI. The destination includes at least one of an MAC CE and a logical channel with the highest priority:
1.1> SL data may be used for transmission; and
1.2> SBj>0, if SBj of any logical channel>0; and
1.3> sl-configuredGrantType1Allowed (if configured) is set to be true, if the SL grant is Configured Grant Type 1; and
1.4> sl-AllowedCG-List (if configured) includes a configured grant index associated with the SL grant; and
1.5> sl-HARQ-FeedbackEnabled is set to be disabled, if a physical sidelink feedback channel (PSFCH) is not configured for the SL grant associated with the SCI.

Notes: If a plurality of destinations have logical channels that meet all the foregoing conditions, and the logical channels have the same highest priority, or if the plurality of destinations have an MAC CE and/or logical channels that meet all the foregoing conditions and have the same priority as that of the MAC CE, the UE determines to select which destination.

Resource reselection can be triggered in the following several situations:
(1) When SL_RESOURCE_RESELECTION_COUNTER=1, the MAC entity uniformly selects a probability between [0, 1], the probability being greater than sl-ProbResourceKeep. Later, when SL_RESOURCE_RESELECTION_COUNTER=0; (refer to 38.133 for an explanation of field sl-ProbResourceKeep-r16);
(2) when no resource is selected from a resource pool;
(3) when an RRC configures/reconfigures the resource pool;
(4) when no transmission/retransmission is performed in a resource obtained in the resource pool in a previous second;
(5) if the RRC has configured sl-ReselectAfter and a quantity of consistently unused transmission occasions is equal to sl-ReselectAfter;
(6) when the resource obtained from the resource pool is insufficient to adapt to a radio link control (RLC) service data unit (SDU) and the UE selects not to partition the RLC SDU; and
(7) when the resource obtained from the resource pool does not satisfy a remaining packet delay budget (PDB) of data in a logical channel with an associated priority.

A channel sharing method provided in an embodiment of this application will be described in detail below through some embodiments and their application scenarios in combination with the accompanying drawings.

For ease of technical understanding, some terms that may be involved in the technical solutions of this application are defined below.

Initiator UE: It is a UE that accesses a channel in a type1 LBT manner in an unlicensed spectrum.

COT-sharing UE: It is a UE that instructs, in an SL-U COT sharing relationship, a peer UE or another UE to use COT shared by the UE. (The COT-sharing UE may not be equivalent to an initiator UE herein. There are two reasons: 1. The initiator UE does not necessarily need to perform COT sharing after preempting a channel. 2. It is not excluded that the COT-sharing UE is not an initiator UE. For example, UE1 is an initiator UE, which shares COT with UE2. After using this COT, UE2 may further share the COT with UE3. In other words, a COT-sharing UE may or may not be an initiator UE).

COT-shared UE: It is a UE that receives, in an SL-U COT sharing relationship, COT sharing information of a COT-sharing UE. The COT-shared UE may be instructed to use a shared piece of COT according to the COT sharing information in the information.

It should be pointed out that in some scenarios, the COT-shared UE is only a UE that receives the COT sharing information, and is not equivalent to a “UE using shared COT”. In some other scenarios, the COT-shared UE is a “UE using shared COT”. Namely, after receiving the COT sharing information, the COT-shared UE may or may not use the shared COT indicated by the information.

shared COT: a piece of COT shared by a COT-sharing UE with a COT-shared UE.

Referring to FIG. 2, an embodiment of this application provides a channel sharing method, including:

Step 201: A first terminal determines COT sharing information.

Step 202: The first terminal transmits the COT sharing information to one or more second terminals.

The COT sharing information is used for indicating shared COT.

In this embodiment of this application, the first terminal determines information content of the COT sharing information for indicating the shared COT, and then transmits the COT sharing information to the one or more second terminals, to implement channel sharing between terminals in an SL-U.

It should be noted that, for example, the above first terminal is a COT-sharing UE, and correspondingly, the second terminal is a COT-shared UE. The COT sharing information determined by the first terminal is COT sharing information. The first terminal transmits the COT sharing information to the second terminal to indicate the shared COT, i.e. shared COT.

It can be understood that a communication relationship may exist between the first terminal and the second terminal. For example, the first terminal and the second terminal communicate with each other by using a sidelink (SL). Or, no communication relationship may exist between the first terminal and the second terminal. For example, UE1 shares COT with UE2. UE2 is in the same group as UE1 only. Then, UE2 transmits data to UE3 by using the shared COT. In this scenario, UE2 has no communication relationship with UE1.

In a possible implementation, the COT sharing information includes one or more of the following:

(1) first information, used for indicating a cast type for the shared COT.

In some embodiments, a name of the first information may be castType, indicating a cast type for the shared COT, for example, unicast, group-cast, broadcast, or any-cast.

(2) second information, used for indicating an identifier of the first terminal.

In some embodiments, a name of the second information may be a first identifier, indicating an ID of the COT-sharing UE.

(3) third information, used for indicating an identifier of the second terminal or an identifier of a terminal group including the second terminal.

In some embodiments, a name of the third information may be a second identifier, indicating an ID of the COT-shared UE (or an ID of a UE group including the COT-shared UE).

(4) fourth information, used for indicating an identifier of a third terminal or an identifier of a terminal group including the third terminal, where the identifier of the third terminal or the identifier of the terminal group including the third terminal is used for allowing the second terminal to use the shared COT to transmit data to the third terminal.

In some embodiments, a name of the fourth information may be a third identifier, indicating an ID of a specified UE (or an ID of a UE group including the specified UE). The third identifier can be used for instructing the COT-shared UE to use the shared COT indicated by the COT sharing information to transmit data to the UE corresponding to the third identifier.

Further, The COT sharing information satisfies one or more of the following:

(1) In a case that the COT sharing information does not include the fourth information, the COT sharing information instructs to allow the second terminal to use the shared COT to transmit the data to the first terminal, or the COT sharing information instructs to allow the second terminal to use the shared COT to transmit control signaling or broadcast data to a destination terminal, where the destination terminal includes the first terminal.

(2) In a case that the COT sharing information includes the fourth information, and a value of the fourth information is a default value, the fourth information is used for instructing to allow the second terminal to use the shared COT to transmit the data to any terminal.

In some embodiments, if an information domain of the fourth information exists, it means that the COT-shared UE can use the shared COT indicated by the COT sharing information to transmit data to the UE corresponding to the third identifier.

If an information domain of the fourth information does not exist, it means that the COT-shared UE can only use the shared COT indicated by the COT sharing information to transmit data to the COT-sharing UE that transmits the COT sharing information, or objects to which the control signaling or broadcast data is sent at least include the COT-sharing UE.

In some embodiments, if a value of the information domain is a default value, it means that the COT-shared UE can use the shared COT indicated by the COT sharing information to transmit the data to any UE.

(5) fifth information, used for indicating whether the second terminal is allowed to share the shared COT with another terminal.

In some embodiments, a name of the fifth information may be flagSharingToOtherUE, indicating whether the COT-shared UE can further share the shared COT with another UE. For example, it is set that 1 indicates OK, and 0 indicates not OK.

(6) sixth information, used for indicating whether the second terminal is allowed to use the shared COT to transmit data, a control signaling, a group-cast message, and/or a broadcast message to another terminal except the first terminal.

In some embodiments, a name of the sixth information may be flagTransmissionToOtherUE, indicating whether the COT-shared UE can use the shared COT indicated by the COT sharing information to transmit data, a control signaling, or a group-cast/broadcast message to a UE except the COT-sharing UE that transmits the COT sharing information.

(7) seventh information, used for indicating whether the shared COT is used for transmitting a PSFCH message.

In some embodiments, a name of the seventh information may be flagHarqFeedback, indicating whether the shared COT indicated by the COT sharing information may be used to transmit PSFCH message.

(8) eighth information, used for indicating time-domain resource information of the shared COT and/or frequency-domain resource information of the shared COT.

(9) ninth information, used for indicating a resource shared by the first terminal with the second terminal.

In some embodiments, a name of the ninth information may be sharedResource, indicating a resource shared by the COT-sharing UE with the COT-shared UE.

(10) tenth information, used for indicating a resource pool shared by the first terminal with the second terminal.

In some embodiments, a name of the tenth information may be sharedResourcePool, indicating a resource pool shared by the COT-sharing UE with the COT-shared UE.

(11) eleventh information, used for indicating a BWP configuration shared by the first terminal with the second terminal.

In some embodiments, a name of the eleventh information may be sharedBWPConfig: indicating a BWP configuration shared by the COT-sharing UE with the COT-shared UE, including, but not limited to, one of the following:
(11.1) a bandwidth of a BWP;
(11.2) a frequency-domain position or a frequency-domain range of the BWP;
(11.3) a time-frequency-domain position of the BWP;
(11.4) a subcarrier spacing (subcarrierSpacing) of the BWP; and
(11.5) a cyclic prefix (CP) configuration of the BWP: whether the CP is an extended CP.

(12) twelfth information, used for indicating an identifier of a terminal that uses the shared COT.

In some embodiments, a name of the twelfth information may be memberID/memberIDlist/memberIDrange. When the COT-sharing UE instructs a group of UEs to use the shared COT, if an ID of the COT-shared UE that receives the COT sharing information is the same as a memberID, or is in a list memberIDlist, or is in a range memberIDrange, the COT-shared UE may use the shared COT indicated by the COT-sharing UE.

(13) thirteenth information, used for indicating, in unit of slot, a time-domain offset between a start time-domain position of the shared COT and a time-domain position at which the COT sharing information is located.

In some embodiments, a name of the thirteenth information may be offsetInSlot, indicating a time-domain offset between a start position of the shared COT and a position at which the COT sharing information is located, in unit of slot.

(14) fourteenth information, used for indicating, in unit of symbol (symbol), a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located.

In some embodiments, a name of the fourteenth information may be offsetInSymbol. The information domain may be used alone to indicate the time-domain offset between the start position of the shared COT and the position at which the COT sharing information is located, in unit of symbol. Or, the information domain can be used together with offsetInSlot to indicate the time-domain offset. For example, the time-domain offset between the start position of the shared COT and the position where the COT sharing information is located is offsetInSymbol+14*offsetInSlot).

(15) fifteenth information, used for indicating a duration of the shared COT in unit of slot.

In some embodiments, a name of the fifteenth information may be durationInSlot, indicating the duration of the shared COT in unit of slot.

(16) sixteenth information, used for indicating a duration of the shared COT in unit of symbol, or indicating the duration of the shared COT jointly with the fifteenth information.

In some embodiments, a name of the sixteenth information may be durationInSymbol: This information domain may be used alone to indicate the duration of the shared COT, in unit of symbol. Or, this information domain may be used together with durationInSlot to indicate the duration of the shared COT (for example, a symbol duration of the shared COT is durationInSymbol+14*durationInSlot).

(17) seventeenth information, indicating a CAPC value, where the CAPC value may be in negative correlation with a corresponding priority. Namely, a smaller CAPC value indicates a higher corresponding priority. Or, the CAPC value may be in positive correlation with a corresponding priority. Namely, a larger CAPC value indicates a higher corresponding priority.

In some implementations, the above COT sharing information may be transmitted through an MAC CE or SCI.

It should be noted that, in an NR-U, the COT sharing information includes an information domain: an offset, a duration, and a CAPC. The COT sharing information in this embodiment of this application may use these information domains, and carry the above information domains described in (1) to (16).

In a possible implementation, before a first terminal transmits COT sharing information to one or more second terminals, the method further includes:

A destination CAPC value used for an LBT operation is determined.

The first terminal determines the destination CAPC value used for the LBT operation by using any one of the following:

Manner I: The first terminal obtains CAPC demand values of the one or more second terminals, and determines the destination CAPC value according to a CAPC demand value with the lowest corresponding priority among the CAPC demand values of the one or more second terminals.

Manner II: The first terminal obtains CAPC demand values of the one or more second terminals, and determines the destination CAPC value according to a CAPC demand value with the highest corresponding priority among the CAPC demand values of the one or more second terminals.

Manner III: The first terminal obtains packet delay budget (PDB) demand values or remaining PDB demand values of data to be transmitted of the one or more second terminals, and determines the destination CAPC value according to the PDB demand values or the remaining PDB demand values of the data to be transmitted of the one or more second terminals.

Manner IV: The first terminal determines the destination CAPC value according to a time-domain position at which the one or more second terminals transmit PSFCH message(s).

In some embodiments, For the foregoing manner I, in this manner, the COT-sharing UE may preempt a channel by using a relatively small CAPC value. Although a duration required by the UE to perform LBT by using the relatively small CAPC value is relatively long, a duration of use of maximum COT corresponding to successful preemption of the channel is relatively long.

If the COT-sharing UE successfully preempts the channel by using CAPC value P1, when the COT-sharing UE uses this COT to transmit data, a CAPC value corresponding to the data should be less than or equal to P1, namely, the priority is higher than or equal to the priority corresponding to P1.

It should be noted that, in this embodiment of this application, the CAPC value being in negative correlation with the corresponding priority is taken as an example for explanation. Namely, a smaller CAPC value indicates a higher corresponding priority. It can be understood that this example is further applicable to a situation in which a larger CAPC value indicates a higher corresponding priority. Essentially, the comparison of the CAPC values is to reflect the comparison of the corresponding priorities. This principle is satisfied in all the following embodiments involving the CAPC values, and details will not be elaborated again.

In some embodiments, in a related example explanation of this embodiment of this application, the COT-sharing UE (UE1) needs to share its own COT with two UEs (UE2 and UE3). For a case in which UE1 shares the COT with a larger quantity of other UEs, reference may be made to for understanding, and details will not be elaborated again.

In some embodiments, the first terminal obtains CAPC demand values of the one or more second terminals, which includes one or more of the following:

(1) The first terminal receives the CAPC demand values from the one or more second terminals.

Namely, UE2 transmits CAPC demand value(s) to UE1 as the CAPC demand value(s) of UE2. It should be noted that, for brevity of description, only UE2 is described. A behavior of UE3 may be correspondingly understood with reference to the behavior of UE2.

In some embodiments, UE2 transmits one CAPC demand value to UE1 as the CAPC demand value of UE2. Or, UE2 transmits a plurality of CAPC demand values to UE1, and UE1 uses a maximum or minimum CAPC value among the plurality of CAPC demand values as the CAPC demand value of UE2.

(2) The first terminal receives QoS Profiles from the one or more second terminals, and determines the CAPC demand values of the one or more second terminals according to CAPC values with the highest or lowest corresponding priorities among CAPC values associated with the QOS Profiles of the one or more second terminals.

In some embodiments, UE2 transmits a QoS Profile of one service to UE1, and UE1 uses a CAPC value associated and mapped with the QoS Profile as the CAPC demand value of UE2. Or, UE2 transmits QoS Profiles of a plurality of services to UE1, and UE1 uses a maximum or minimum CAPC value among CAPC values associated and mapped with the plurality of QoS Profiles as the CAPC demand value of UE2.

(3) The first terminal determines the CAPC demand values of the one or more second terminals according to CAPC values with the highest or lowest corresponding priorities among CAPC values associated with QoS Flows transmitted between the first terminal and the one or more second terminals.

In some embodiments, UE1 (implicitly) uses a CAPC value corresponding to a QoS flow service transmitted by UE2 as the CAPC demand value of UE2. UE1 (implicitly) uses a maximum or minimum CAPC value among CAPC values corresponding to a plurality of QoS flows transmitted by UE2 as the CAPC demand values of UE2.

(4) The first terminal transmits a CAPC demand value request to the one or more second terminals, and receives the CAPC demand values from the one or more second terminals.

In some embodiments, UE1 transmits a CAPC demand value request to UE2. The request may be transmitted through SCI or an MAC CE. UE2 then transmits CAPC demand value information to UE1. The request may be sent through the SCI or the MAC CE.

For example, UE1 may transmit an inter-UE coordination request MAC CE or an enhanced inter-UE coordination request MAC CE to UE2 to request a CAPC demand value. UE2 may transmit inter-UE coordination information MAC CE or enhanced inter-UE coordination information to UE1 to inform UE1 of the CAPC demand value.

The CAPC demand value may be directly included in the MAC CE, or may be obtained by using a method such as indirect association, derivation, or mapping of an information domain of the MAC CE.

In Manner I, after the first terminal obtains CAPC demand values of the one or more second terminals, the method further includes:

UE1 performs, by using CAPC value P1 (since P1>P2, the priority corresponding to P1 is relatively low), type 1 LBT to attempt to access a channel.

After successfully accessing the channel, UE1 transmits the COT sharing information to UE2 and/or UE3 within an allowed range of maximum COT corresponding to CAPC value P1.

UE1 preempts the channel by using the relatively low CAPC priority, and the maximum COT corresponding to the relatively low CAPC priority is relatively long, so it is easier to perform COT sharing on a plurality of UEs.

In some embodiments, for foregoing Manner II, in this manner, the COT-sharing UE uses the CAPC demand value with the highest priority of a plurality of SL UEs, to determine a CAPC value used by the COT-sharing UE to perform LBT.

In comparison manner I, since a UE uses a CAPC value with a relatively low priority to attempt to perform LBT to access a channel, the success rate may be low or a duration for accessing the channel may be long, which may not meet the requirements of some high-priority services, such as a PDB requirement. Therefore, in Manner II, it is considered using the CAPC demand value with the highest priority of the plurality of SL UEs to attempt to access the channel. (e.g. p=1 or 2)

For example, the COT-sharing UE (UE1) needs to share its own COT with two UEs (UE2 and UE3).

In some embodiments, the first terminal obtains CAPC demand values of the one or more second terminals, which includes one or more of the following:

(1) The first terminal receives the CAPC demand values from the one or more second terminals.

Namely, UE2 transmits CAPC demand value(s) to UE1 as the CAPC demand value(s) of UE2. It should be noted that, for brevity of description, only UE2 is described. A behavior of UE3 may be correspondingly understood with reference to the behavior of UE2.

In some embodiments, UE2 transmits one CAPC demand value to UE1 as the CAPC demand value of UE2. Or, UE2 transmits a plurality of CAPC demand values to UE1, and UE1 uses a maximum or minimum CAPC value among the plurality of CAPC demand values as the CAPC demand value of UE2.

(2) The first terminal receives QoS Profiles from the one or more second terminals, and determines the CAPC demand values of the one or more second terminals according to CAPC values with the highest or lowest corresponding priorities among CAPC values associated with the QOS Profiles of the one or more second terminals.

In some embodiments, UE2 transmits a QoS Profile of one service to UE1, and UE1 uses a CAPC value associated and mapped with the QoS Profile as the CAPC demand value of UE2. Or, UE2 transmits QoS Profiles of a plurality of services to UE1, and UE1 uses a maximum or minimum CAPC value among CAPC values associated and mapped with the plurality of QoS Profiles as the CAPC demand value of UE2.

(3) The first terminal determines the CAPC demand values of the one or more second terminals according to CAPC values with the highest or lowest corresponding priorities among CAPC values associated with QoS Flows transmitted between the first terminal and the one or more second terminals.

In some embodiments, UE1 (implicitly) uses a CAPC value corresponding to a QoS flow of one service transmitted by UE2 as the CAPC demand value of UE2. UE1 (implicitly) uses a maximum or minimum CAPC value among CAPC values corresponding to QoS flows of a plurality of services transmitted by UE2 as the CAPC demand values of UE2.

(4) The first terminal transmits a CAPC demand value request to the one or more second terminals, and receives the CAPC demand values from the one or more second terminals.

In some embodiments, UE1 transmits a CAPC demand value request to UE2. The request may be transmitted through SCI or an MAC CE. UE2 then transmits CAPC demand value information to UE1. The request may be transmitted through the SCI or the MAC CE.

For example, UE1 may transmit an inter-UE coordination request MAC-UE or an enhanced inter-UE coordination request MAC CE to UE2 to request a CAPC demand value. UE2 may transmit inter-UE coordination information MAC-UE Coordination Information MAC CE or enhanced inter-UE coordination information to UE1 to inform UE1 of the CAPC demand value.

The CAPC demand value may be directly included in the MAC CE, or may be obtained by using a method such as indirect association, derivation, or mapping of an information domain of the MAC CE.

In Manner II, after the first terminal obtains CAPC demand values of the one or more second terminals, the method further includes:

UE1 performs, by using CAPC value P2 (since P1>P2), type 1 LBT to attempt to access a channel.

After successfully accessing the channel, UE1 transmits the COT sharing information to UE3 within an allowed range of maximum COT corresponding to CAPC value P2. It should be noted that, since the CAPC demand value of UE2 is P1 (the priority of which is lower than that of P2), which does not satisfy a condition that UE1 shares the COT with UE2 after preempting the channel by using P1, it does not include indicating UE2 of COT sharing.

UE1 preempts a channel by using a relatively high CAPC priority, and can preempt the channel quickly and perform COT sharing with another UE.

In some embodiments, for foregoing Manner III, in this manner, the CAPC value selected by the COT-sharing UE meets a PDB or remaining PDB requirement of data to be transmitted of the COT-shared UE.

In some embodiments, when the COT-shared UE transmits a PDB or remaining PDB requirement to the COT-sharing UE, the COT-sharing UE uses the CAPC value with the highest priority.

For example, when UE1 shares the COT with UE2, a PDB or remaining PDB requirement of data to be transmitted of UE2 needs to be considered. If UE1 preempts the channel by using a relatively small CAPC value, and shares the COT with UE2 when it has preempted the channel, it is too late to meet the PDB or remaining PDB requirement of the data to be transmitted of UE2. Therefore, a UE needs to preempt a channel by using a CAPC value with the highest priority.

In some embodiments, when the COT-shared UE transmits a PDB or remaining PDB requirement to the COT-sharing UE, the COT-sharing UE uses a CAPC value with a priority that is matched/mapped with the PDB or remaining PDB requirement. The matching/mapping relationship may be configured/preconfigured by a base station, or may be agreed on in an agreement.

In some embodiments, the first terminal obtains PDB demand values or remaining PDB demand values of data to be transmitted of the one or more second terminals, which includes one or more of the following:

(1) The first terminal receives the PDB demand values or the remaining PDB demand values from the one or more second terminals.

In some embodiments, UE2 transmits a PDB or remaining PDB demand value to UE1 as the PDB or remaining PDB demand value of UE2. Or, UE2 transmits a plurality of PDB or remaining PDB demand values to UE1, and UE1 uses a maximum or minimum PDB or remaining PDB value among the plurality of PDB demand values as the PDB or remaining PDB demand value of UE2.

(2) The first terminal receives QoS Profiles from the one or more second terminals, and determines the PDB demand values or the remaining PDB demand values of the one or more second terminals according to PDB demand values or remaining PDB demand values associated with the QoS Profiles of the one or more second terminals.

In some embodiments, UE2 transmits a QoS Profile of one service to UE1, and UE1 uses a PDB or remaining PDB value of the QoS Profile as the PDB or remaining PDB demand value of UE2. Or, UE2 transmits QoS Profiles of a plurality of services to UE1, and UE1 uses a maximum or minimum PDB or remaining PDB value among the PDB values of the plurality of QOS Profiles as the PDB or remaining PDB demand value of UE2.

(3) The first terminal determines the PDB demand values or the remaining PDB demand values of the one or more second terminals according to PDB demand values or remaining PDB demand values associated with QoS flows transmitted between the first terminal and the one or more second terminals.

In some embodiments, UE1 (implicitly) uses a PDB or remaining PDB value corresponding to a QoS flow of one service transmitted by UE2 as the PDB or remaining PDB demand value of UE2. Or, UE1 (implicitly) uses a maximum or minimum PDB or remaining PDB value among PDB or remaining PDB values corresponding to QoS Flows of a plurality of services transmitted by UE2 as the PDB or remaining PDB demand value of UE2.

(4) The first terminal transmits a PDB demand value request or a remaining PDB demand value request to the one or more second terminals, and receives the PDB demand values or the remaining PDB demand values from the one or more second terminals.

UE1 transmits a PDB or remaining PDB demand value request to UE2. The request may be sent through SCI or an MAC CE. UE2 then transmits PDB or remaining PDB demand value information to UE1. The remaining PDB demand value information may be transmitted through the SCI or the MAC CE.

For example, UE1 may transmit an inter-UE coordination request MAC CE or an enhanced inter-UE coordination request MAC CE to UE2 to request a PDB or remaining PDB demand value. UE2 may transmit inter-UE coordination information MAC CE or enhanced inter-UE coordination information to UE1 to inform UE1 of the PDB or remaining PDB demand value.

The PDB or remaining PDB demand value may be directly included in the MAC CE, or may be obtained by using a method such as indirect association, derivation, or mapping of an information domain of the MAC CE.

In some embodiments, for foregoing manner IV, in this manner, when the COT-sharing UE requires one or more peer UEs to transmit hybrid automatic repeat request (HARQ) feedback(s) (feedback), i.e. PSFCH message(s), to it, a duration of a channel preempted using a CAPC value selected by the COT-sharing UE needs to cover a position at which the one or more peer UEs transmit the PSFCH message(s).

For example, when UE1 transmits data to UE2 and UE3 and needs to receive PSFCHs of UE2 and UE3, the PSFCHs are transmitted in a manner that UE1 preempts a channel and shares COT with UE2 and UE3. Note: in the following method, slot being used as a time-domain unit is taken as an example, but is not limited to slot. In some embodiments, the method may be applied to scenarios in unit of symbol and in unit of symbol and slot, and details will not be elaborated again.

In some embodiments, the first terminal determines the destination CAPC value according to a time-domain position at which the one or more second terminals transmit PSFCH message(s), which includes:

(1) The first terminal separately determines one or more destination CAPC values according to the time-domain position at which each of the one or more second terminals transmits the PSFCH message. Namely, UE1 separately considers transmissions of UE2 and UE3.

For example, if UE1 starts to transmit, to UE2 in slot n1, a PSSCH occupying ml slots, and UE2 starts to feed back, to UE1 in slot n2, a PSFCH occupying m2 slots (if the PSFCH uses only one or more consecutive symbols, the PSFCH is equivalent to occupying one slot),

step 1: UE1 determines CAPC value P1 according to this. The CAPC value should satisfy maximum COT Tmcot corresponding to the CAPC value>=n2−n1+m2. UE1 transmits data to UE2 by using the successfully preempted channel, and shares the COT with UE2.

step 2: UE1 then determines a CAPC value for correspondingly preempting a channel in the same wan and transmits data to UE3.

For a specific process, refer to FIG. 3a.

Or, (2) the first terminal determines one destination CAPC value jointly according to the time-domain position at which all the second terminals among the one or more second terminals transmit the PSFCH messages. Namely, UE1 jointly considers transmissions of UE2 and UE3.

For example, if UE1 starts to transmit, to UE2 in slot n1, a PSSCH occupying ml slots, and UE2 starts to feed back, to UE1 in slot n2, a PSFCH occupying m2 slots, and if UE1 starts to transmit, to UE3 in slot n3 (n3 is after n2), a PSSCH occupying m3 slots, and UE3 starts to feed back, to UE1 in slot n4, a PSFCH occupying m4 slots,

step 1: UE1 determines CAPC value P2 according to this. The CAPC value should satisfy maximum COT Tmcot corresponding to the CAPC value>=n4−n1+m4.

step 2: UE1 then transmits data to UE2 and UE3 by using the successfully preempted channel, and shares the COT with UE2 and UE3.

For a specific process, refer to FIG. 3b. The illustrated method may be further similarly used in a scenario including more than two UEs.

After successfully preempting the channel, UE1 can ensure to transmit data to one or more UEs, and can enable, by COT sharing, the peer UEs to have a large probability of using the PSFCH resources fed back to UE1.

In a possible implementation, before a first terminal determines COT sharing information, the method further includes:

The first terminal determines a second terminal satisfying a first condition to be a destination receiving object of the COT sharing information. Namely, when the COT-sharing UE needs to perform COT sharing with a plurality of COT-shared UEs, destination COT-sharing UEs are determined.

The first condition includes one or more of the following:
(1) the highest priority among priorities corresponding to one or more CAPC demand values of the second terminal is lower than or equal to a first priority;
(2) the highest priority among the priorities corresponding to the one or more CAPC demand values of the second terminal is lower than or equal to a second priority.

The first priority is a priority corresponding to a CAPC value used by the first terminal for determining the shared COT, and the second priority is lower than or equal to the first priority.

After a UE preempts a channel by using CAPC value P1 to obtain a piece of COT, if the UE performs COT sharing to share a part of the COT with one or more peer UEs, the UE selects a CAPC demand value of the peer UEs sharing the COT, or minimum CAPC value P2 (which is a CAPC value corresponding to the highest priority) among a plurality of CAPC demand values. P2 should satisfy P2<=P1, namely, the priority corresponding to CAPC value P2 is not lower than the priority corresponding to P1. Therefore, in this case, the step that the UE selects a candidate destination is as follows:

step 1: When the UE has preempted the channel by using CAPC value P1 (performing type 1 LBT), the UE uses a peer UE that satisfies at least one of the following conditions as a candidate destination:
(a) if one CAPC demand value of the peer UE or minimum CAPC value P2 (which is a CAPC value corresponding to the highest priority) among a plurality of CAPC demand values of the peer UE satisfies P2<=P1; and
(b) if one CAPC demand value of the peer UE or minimum CAPC value P2 (which is a CAPC value corresponding to the highest priority) among a plurality of CAPC demand values of the peer UE satisfies P2<=P3 and P3<=P1. Namely, the priority of P3 is not lower than that of P1. The value of P3 may be determined by the UE, or may be configured by a network.

step 2: If there is only one candidate destination, the UE selects the candidate destination as a final destination. Otherwise, the UE determines to select the destination.

In a possible implementation, the determining, by the first terminal, COT sharing information includes:

When a second condition is met, the first terminal determines the COT sharing information.

The second condition includes any one of the following:
(1) a cache of the first terminal has data to be transmitted to a first destination object, and a CAPC priority or an SL logical channel priority corresponding to the data to be transmitted is higher than or equal to a first threshold, where the first destination object is an SL peer terminal or a group-cast object of the first terminal;
(2) a cache of the first terminal has data to be transmitted to a first destination object, and a CAPC priority or an SL logical channel priority corresponding to the data to be transmitted is less than or equal to a second threshold, where the first destination object is an SL peer terminal or a group-cast object of the first terminal; and
(3) an energy detection result or a reference signal received power (RSRP) measurement result of LBT performed by the first terminal is less than or equal to a third threshold.

The first threshold, the second threshold, and the third threshold are configured by a network, configured by another terminal, or agreed on in an agreement.

A triggering condition for COT sharing includes two manners:

Manner I: Based on the priority of the data to be transmitted

step 1: A UE obtains a priority threshold through network configuration or an agreement.

step 2: If a cache of the UE has data to be transmitted to a first destination, the first destination being a peer UE or a group-cast object, and a CAPC priority or an SL logical channel priority corresponding to the data to be transmitted is higher than or equal to (or lower than or equal to) the priority threshold, the UE triggers performing COT sharing with the first destination.

step 3: The UE transmits COT sharing information to the first destination.

Manner II: Based on a reference signal received power (RSRP) threshold of an energy detection or received signal of LBT

step 1: A UE obtains an RSRP threshold through network configuration or an agreement.

step 2: if an RSRP value obtained by performing energy detection or received signal RSRP measurement by the UE in the process of performing the LBT is less than or equal to the RSRP threshold, the UE may share COT with another UE after the LBT succeeds.

In some embodiments, the above priority threshold or the RSRP threshold may be configured by a network side device, or may be configured by another UE.

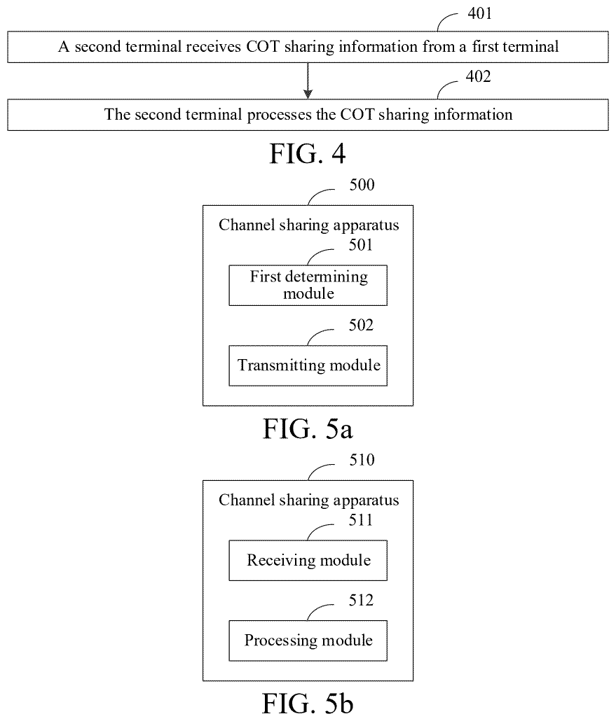

Referring to FIG. 4, an embodiment of this application provides a channel sharing method, including:

Step 401: A second terminal receives COT sharing information from a first terminal.

Step 402: The second terminal processes the COT sharing information.

The COT sharing information is used for indicating shared COT.

In this embodiment of this application, the first terminal determines information content of the COT sharing information for indicating the shared COT, and then transmits the COT sharing information to the one or more second terminals, to implement channel sharing between terminals in an SL-U.

It should be noted that, for example, the above first terminal is a COT-sharing UE, and correspondingly, each second terminal is a COT-shared UE. The COT sharing information determined by the first terminal is COT sharing information. The first terminal transmits the COT sharing information to each second terminal to indicate the shared COT, i.e. shared COT.

It can be understood that a mutual communication relationship may exist between the first terminal and each second terminal. For example, the first terminal and each second terminal communicate with each other by using a sidelink (SL). Or, only COT sharing is involved between the first terminal and the second terminal, but there is no mutual communication between the first terminal and the second terminal. For example: UE1 shares COT with UE2. UE2 is in the same group as UE1 only. Then, UE2 transmits data to UE3 by using the shared COT.

In a possible implementation, the COT sharing information includes one or more of the following:

(1) first information, used for indicating a cast type for the shared COT.

In some embodiments, a name of the first information may be castType, indicating a cast type for the shared COT, such as, unicast, group-cast, broadcast, or any-cast.

(2) second information, used for indicating an identifier of the first terminal.

In some embodiments, a name of the second information may be a first identifier, indicating an ID of the COT-sharing UE.

(3) third information, used for indicating an identifier of the second terminal or used for indicating an identifier of a terminal group including the second terminal.

In some embodiments, a name of the third information may be a second identifier, indicating an ID of the COT-shared UE (or an ID of a UE group including the COT-shared UE).

(4) fourth information, used for indicating an identifier of a third terminal, or used for indicating an identifier of a terminal group including the third terminal, where the identifier of the third terminal or the identifier of the terminal group including the third terminal is used for allowing the second terminal to use the shared COT to transmit data to the third terminal.

In some embodiments, a name of the fourth information may be a third identifier, indicating an ID of a specified UE (or an ID of a UE group including the specified UE). The third identifier can be used for instructing the COT-shared UE to use the shared COT indicated by the COT sharing information to transmit data to the UE corresponding to the third identifier.

Further, The COT sharing information satisfies one or more of the following:

(1) In a case that the COT sharing information does not include the fourth information, the COT sharing information instructs to allow the second terminal to use the shared COT to transmit the data to the first terminal, or the COT sharing information instructs to allow the second terminal to use the shared COT to transmit control signaling or broadcast data to a destination terminal, where the destination terminal includes the first terminal.

(2) In a case that the COT sharing information includes the fourth information, and a value of the fourth information is a default value, the fourth information is used for instructing to allow the second terminal to use the shared COT to transmit the data to any terminal.

In some embodiments, if an information domain of the fourth information exists, it means that the COT-shared UE can use the shared COT indicated by the COT sharing information to transmit data to the UE corresponding to the third identifier.

If an information domain of the fourth information does not exist, it means that the COT-shared UE can only use the shared COT indicated by the COT sharing information to transmit data to the COT-sharing UE that transmits the COT sharing information, or objects to which a control signaling or broadcast data is transmitted at least include the COT-sharing UE.

In some embodiments, if a value of the information domain is a default value, it means that the COT-shared UE can use the shared COT indicated by the COT sharing information to transmit data to any UE.

(5) fifth information, used for indicating whether the second terminal is allowed to share the shared COT with another terminal.

In some embodiments, a name of the fifth information may be flagSharingToOtherUE, indicating whether the COT-shared UE may further share the shared COT with another UE. For example, it is set that 1 indicates OK, and 0 indicates not OK.

(6) sixth information, used for indicating whether the second terminal is allowed to use the shared COT to transmit data, a control signaling, a group-cast message, and/or a broadcast message to another terminal except the first terminal.

In some embodiments, a name of the sixth information may be flagTransmissionToOtherUE, indicating whether the COT-shared UE can use the shared COT indicated by the COT sharing information to transmit data, a control signaling, or a group-cast/broadcast message to a UE except the COT-sharing UE that transmits the COT sharing information.

(7) seventh information, used for indicating whether the shared COT is used for transmitting a PSFCH message.

In some embodiments, a name of the seventh information may be flagHarqFeedback, indicating whether the shared COT indicated by the COT sharing information may be used to transmit PSFCH.

(8) eighth information, used for indicating time-domain resource information of the shared COT and/or frequency-domain resource information of the shared COT.

(9) ninth information, used for indicating a resource shared by the first terminal with the second terminal.

In some embodiments, a name of the ninth information may be sharedResource, indicating the resource shared by the COT-sharing UE with the COT-shared UE.

(10) tenth information, used for indicating a resource pool shared by the first terminal with the second terminal.

In some embodiments, a name of the tenth information may be sharedResourcePool, indicating the resource pool shared by the COT-sharing UE with the COT-shared UE.

(11) eleventh information, used for indicating a BWP configuration shared by the first terminal with the second terminal.

In some embodiments, a name of the eleventh information may be sharedBWPConfig: indicating the BWP configuration shared by the COT-sharing UE with the COT-shared UE, including, but not limited to, one of the following:
(11.1) a bandwidth of a BWP;
(11.2) a frequency-domain position or a frequency-domain range of the BWP;
(11.3) a time-frequency-domain position of the BWP;
(11.4) a subcarrier spacing (subcarrierSpacing) of the BWP; and
(11.5) a cyclic prefix (CP) configuration of the BWP: whether the CP is an extended CP.

(12) twelfth information, used for indicating an identifier of a terminal that uses the shared COT.

In some embodiments, a name of the twelfth information may be memberID/memberIDlist/memberIDrange. When the COT-sharing UE instructs a group of UEs to use the shared COT, if an ID of the COT-shared UE that receives the COT sharing information is the same as a memberID, or is in a list memberIDlist, or is in a range memberIDrange, the COT-shared UE may use the shared COT indicated by the COT-sharing UE.

(13) thirteenth information, used for indicating, in unit of slot, a time-domain offset between a start time-domain position of the shared COT and a time-domain position at which the COT sharing information is located.

In some embodiments, a name of the thirteenth information may be offsetInSlot, indicating a time-domain offset between a start position of the shared COT and a position at which the COT sharing information is located, in unit of slot.

(14) fourteenth information, used for indicating, in unit of symbol, a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located.

In some embodiments, a name of the fourteenth information may be offsetInSymbol. The information domain may be used alone to indicate the time-domain offset between the start position of the shared COT and the position at which the COT sharing information is located, in unit of symbol. Or, the information domain can be used together with offsetInSlot to indicate the time-domain offset. For example, the time-domain offset between the start position of the shared COT and the position where the COT sharing information is located is offsetInSymbol+14*offsetInSlot).

(15) fifteenth information, used for indicating a duration of the shared COT in unit of slot.

In some embodiments, a name of the fifteenth information may be durationInSlot, indicating the duration of the shared COT in unit of slot.

(16) sixteenth information, used for indicating a duration of the shared COT in unit of symbol, or indicating the duration of the shared COT jointly with the fifteenth information.

In some embodiments, a name of the sixteenth information may be durationInSymbol: This information domain may be used alone to indicate the duration of the shared COT, in unit of symbol. Or, this information domain may be used together with durationInSlot to indicate the duration of the shared COT (for example, a symbol duration of the shared COT is durationInSymbol+14*durationInSlot).

(17) seventeenth information, indicating a CAPC value, where the CAPC value may be in negative correlation with a corresponding priority. Namely, a smaller CAPC value indicates a higher corresponding priority. Or, the CAPC value may be in positive correlation with a corresponding priority. Namely, a larger CAPC value indicates a higher corresponding priority.

In some implementations, the above COT sharing information may be transmitted through an MAC CE or SCI.

It should be noted that, in an NR-U, the COT sharing information includes an information domain: an offset, a duration, and a CAPC. The COT sharing information in this embodiment of this application may use these information domains, and carry the above information domains described in (1) to (16).

In a possible implementation, the method further includes one or more of the following:

(1) The second terminal transmits a CAPC demand value to the first terminal.

(2) The second terminal transmits a QoS Profile to the first terminal.

(3) The second terminal receives a CAPC demand value request from the first terminal, and transmits a CAPC demand value to the first terminal.

In the foregoing manner, the second terminal provides the CAPC demand value to the first terminal, so that the first terminal determines a CAPC value for performing an LBT operation.

In a possible implementation, the method further includes one or more of the following:

(1) The second terminal transmits a PDB demand value or a remaining PDB demand value to the first terminal.

(2) The second terminal transmits a QoS Profile to the first terminal.

(3) The second terminal receives a PDB demand value request or a remaining PDB demand value request from the first terminal, and transmits a PDB demand value or a remaining PDB demand value to the first terminal.

In the foregoing manner, the second terminal provides the PDB demand value or the remaining PDB demand value to the first terminal, so that the first terminal determines a CAPC value for performing an LBT operation.

In a possible implementation, the second terminal processes the COT sharing information, which includes:

The second terminal uses the shared COT in a case that a third condition is satisfied. Namely, when a COT-sharing UE transmits COT sharing information to a plurality of COT-shared UEs, the COT-shared UEs may use conditions of the indicated shared COT.

The third condition includes one or more of the following:

(1) The second terminal transmits a PSFCH message to the first terminal.

Namely, the second terminal has a PSFCH to be transmitted, which is fed back to the COT-sharing UE.

(2) A priority corresponding to a CAPC value of data to be transmitted of the second terminal is higher than or equal to a priority corresponding to a CAPC value indicated in the COT sharing information.

Namely, the CAPC value of the data to be transmitted is not greater than the CAPC value indicated in the COT-sharing indication information.

The CAPC value may mean a channel preempted by the COT-sharing UE by using which CAPC value. Or, the CAPC value may mean that the COT-sharing UE instructs the COT-shared UE to use the shared COT at which CAPC value.

(3) A group-cast destination identifier of a group-cast service transmitted by the second terminal using the shared COT is a group-cast destination identifier that the first terminal expects to receive.

In some embodiments, the group-cast destination identifier that the first terminal expects to receive is an identifier indicated by the third information or an identifier indicated by the fourth information. Or, the group-cast destination identifier that the first terminal expects to receive is a destination identifier indicated by destination SCI and/or a destination MAC CE, where the destination SCI is SCI that is received by the second terminal from the first terminal and carries the COT sharing information, and the destination MAC CE is an MAC CE that is received by the second terminal from the first terminal and carries the COT sharing information.

A group-cast destination ID of a group-cast service transmitted by the COT-shared UE by using the shared COT is a group-cast destination ID that the COT-sharing UE expects to receive. In some embodiments, before receiving the COT sharing information, the COT-shared UE receives the group-cast destination ID that the COT-sharing UE expects to receive and that is indicated by a network side device or the COT-sharing UE.

(4) An identifier of the second terminal is the same as an identifier, indicated in the COT sharing information, of a terminal that uses the shared COT.

Namely, the ID of the COT-shared UE is the same as one of at least one group member ID by which the COT-sharing UE instructs, through the COT sharing information, to use the shared COT.

(5) An identifier of the second terminal is included in an identifier, indicated in the COT sharing information, of a terminal that can use the shared COT.

Namely, the ID of the COT-shared UE is in an ID list or an ID range within which the COT-sharing UE instructs, through the COT sharing information, to use the shared COT.

In a possible implementation, the second terminal processes the COT sharing information, which includes:

The second terminal triggers one or more of resource selection, resource reselection, resource selection check, and reselection check according to the COT sharing information. Namely, when the COT-shared UE receives the COT sharing information or the shared COT indicated by the COT-sharing UE, the COT-shared UE triggers resource selection/reselection or resource selection/reselection check.

In a possible implementation, the second terminal processes the COT sharing information, which includes:

(1) The second terminal transmits a first indication from a physical layer of the second terminal to a medium access control (MAC) layer of the second terminal according to the COT sharing information.

(2) The MAC layer of the second terminal instructs, according to the first indication, the physical layer of the second terminal to trigger resource selection or resource reselection.

(3) The physical layer of the second terminal performs a first operation.

The first indication includes one or more of the following:

(1) first indication information, used for indicating that the second terminal has received the COT sharing information;

(2) second indication information, used for indicating that the second terminal has received the shared COT; and

(3) third indication information, used for instructing the MAC layer of the second terminal to trigger resource selection check or resource reselection check.

The first operation includes one or more of the following:
(1) performing a resource selection procedure or a resource reselection procedure to form a selectable resource set, and informing the MAC layer of the second terminal of the selectable resource set; and
(2) performing the resource selection or resource reselection according to a resource indicated by the COT sharing information.

To be specific:

step 1: The COT-shared UE receives the COT sharing information carried by the COT-sharing UE in the SCI.

step 2: A PHY layer of the COT-shared UE transmits an indication to an MAC layer. The indication is used for achieving at least one of the following:
(a) representing that the COT sharing information has been received;
(b) representing that the shared COT has been received; and
(c) instructing the MAC layer to trigger resource selection/reselection check.

step 3: The MAC layer of the COT-shared UE instructs the PHY layer to trigger resource selection/reselection.

step 4: The COT-shared UE performs at least one of the following at the PHY layer:

(a) performing a resource selection/reselection procedure to form a selectable resource set, and informing the MAC layer; and

(b) considering/evaluating a shared COT resource indicated by the COT sharing information during resource selection/reselection.

An executive body of the channel sharing method provided in this embodiment of this application may be a channel sharing apparatus. In this embodiment of this application, the channel sharing apparatus performing the channel sharing method is taken as an example to explain the channel sharing apparatus provided in an embodiment of this application.

Referring to FIG. 5a, an embodiment of this application provides a channel sharing apparatus 500. The apparatus may be applied to the first terminal in the foregoing method description, and includes:

a first determining module 501, configured to determine COT sharing information, where the COT sharing information is used for indicating shared COT; and

a first transmitting module 502, configured to transmit the COT sharing information to one or more second terminals.

In a possible implementation, the COT sharing information includes one or more of the following:
first information, used for indicating a cast type for the shared COT;
second information, used for indicating an identifier of the first terminal;
third information, used for indicating an identifier of the second terminal, or indicating an identifier of a terminal group including the second terminal;
fourth information, used for indicating an identifier of a third terminal, or indicating an identifier of a terminal group including the third terminal, where the identifier of the third terminal or the identifier of the terminal group including the third terminal is used for allowing the second terminal to use the shared COT to transmit data to the third terminal;
fifth information, used for indicating whether the second terminal is allowed to share the shared COT with another terminal;
sixth information, used for indicating whether the second terminal is allowed to use the shared COT to transmit data, a control signaling, a group-cast message, and/or a broadcast message to another terminal except the first terminal;
seventh information, used for indicating whether the shared COT is used for transmitting a PSFCH message;
eighth information, used for indicating time-domain resource information of the shared COT and/or frequency-domain resource information of the shared COT;
ninth information, used for indicating a resource shared by the first terminal with the second terminal;
tenth information, used for indicating a resource pool shared by the first terminal with the second terminal;
eleventh information, used for indicating a bandwidth part (BWP) configuration shared by the first terminal with the second terminal;
twelfth information, used for indicating an identifier of a terminal that uses the shared COT;
thirteenth information, used for indicating, in unit of slot, a time-domain offset between a start time-domain position of the shared COT and a time-domain position at which the COT sharing information is located;
fourteenth information, used for indicating, in unit of symbol, a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located;
fifteenth information, used for indicating a duration of the shared COT in unit of slot;
sixteenth information, used for indicating a duration of the shared COT in unit of symbol, or indicating the duration of the shared COT jointly with the fifteenth information; and
seventeenth information, used for indicating a CAPC value.

In a possible implementation, the COT sharing information satisfies one or more of the following:
in a case that the COT sharing information does not include the fourth information, the COT sharing information instructs to allow the second terminal to use the shared COT to transmit the data to the first terminal, or the COT sharing information instructs to allow the second terminal to use the shared COT to transmit the control signaling or broadcast data to a destination terminal, where the destination terminal includes the first terminal; and
in a case that the COT sharing information includes the fourth information, and a value of the fourth information is a default value, the fourth information is used for instructing to allow the second terminal to use the shared COT to transmit the data to any terminal.

In a possible implementation, the apparatus further includes:
a second determining module, configured to determine, before transmitting the COT sharing information to the one or more second terminals, a destination CAPC value used for an LBT operation through any one of the following:
the first terminal obtains CAPC demand values of the one or more second terminals, and determines the destination CAPC value according to a CAPC demand value with the lowest corresponding priority among the CAPC demand values of the one or more second terminals;
the first terminal obtains CAPC demand values of the one or more second terminals, and determines the destination CAPC value according to a CAPC demand value with the highest corresponding priority among the CAPC demand values of the one or more second terminals;
the first terminal obtains packet delay budget (PDB) demand values or remaining PDB demand values of data to be transmitted of the one or more second terminals, and determines the destination CAPC value according to the PDB demand values or the remaining PDB demand values of the data to be transmitted of the one or more second terminals; and
the first terminal determines the destination CAPC value according to a time-domain position at which the one or more second terminals transmit PSFCH message(s).

In a possible implementation, the second determining module is configured to perform one or more of the following:
receiving, by the first terminal, the CAPC demand values from the one or more second terminals;
receiving, by the first terminal, quality of service (QOS) Profile from the one or more second terminals, and determining the CAPC demand values of the one or more second terminals according to CAPC values with the highest or lowest corresponding priorities among CAPC values associated with the QoS Profiles of the one or more second terminals;
determining, by the first terminal, the CAPC demand values of the one or more second terminals according to CAPC values with the highest or lowest corresponding priorities among CAPC values associated with quality of service (QOS) Flow transmitted between the first terminal and the one or more second terminals; and
transmitting, by the first terminal, a CAPC demand value request to the one or more second terminals, and receiving the CAPC demand values from the one or more second terminals.

In a possible implementation, the second determining module is configured to perform one or more of the following:
receiving, by the first terminal, the PDB demand values or the remaining PDB demand values from the one or more second terminals;
receiving, by the first terminal, QoS Profiles from the one or more second terminals, and determining the PDB demand values or the remaining PDB demand values of the one or more second terminals according to PDB demand values or remaining PDB demand values associated with the QoS Profiles of the one or more second terminals;
determining, by the first terminal, the PDB demand values or the remaining PDB demand values of the one or more second terminals according to PDB demand values or remaining PDB demand values associated with QoS Flows transmitted between the first terminal and the one or more second terminals; and
transmitting, by the first terminal, a PDB demand value request or a remaining PDB demand value request to the one or more second terminals, and receiving the PDB demand values or the remaining PDB demand values from the one or more second terminals.

In a possible implementation, the second determining module is configured to:
separately determine, by the first terminal, one or more target CAPC values according to the time-domain position at which each of the one or more second terminals transmits the PSFCH message;
or,
determine, by the first terminal, one destination CAPC value jointly based on time-domain positions at which PSFCH messages are transmitted by all the second terminals among the one or more second terminals.

In a possible implementation, the apparatus further includes:
a third determining module, configured to determine, before determining the COT sharing information, a second terminal satisfying a first condition to be a destination receiving object of the COT sharing information.

The first condition includes one or more of the following:
the highest priority among priorities corresponding to one or more CAPC demand values of the second terminal is lower than or equal to a first priority; and
the highest priority among the priorities corresponding to the one or more CAPC demand values of the second terminal is lower than or equal to a second priority.

The first priority is a priority corresponding to a CAPC value used by the first terminal for determining the shared COT, and the second priority is lower than or equal to the first priority.

In a possible implementation, the first determining module is configured to:
determine the COT sharing information in a case that a second condition is satisfied.

The second condition includes any one of the following:
a cache of the first terminal has data to be transmitted to a first destination object, and a CAPC priority or an SL logical channel priority corresponding to the data to be transmitted is higher than or equal to a first threshold, where the first destination object is an SL peer terminal or a group-cast object of the first terminal;
a cache of the first terminal has data to be transmitted to a first destination object, and a CAPC priority or an SL logical channel priority corresponding to the data to be transmitted is less than or equal to a second threshold, where the first destination object is an SL peer terminal or a group-cast object of the first terminal; and
an energy detection result or a reference signal received power (RSRP) measurement result of LBT performed by the first terminal is less than or equal to a third threshold.

The first threshold, the second threshold, and the third threshold are configured by a network, configured by another terminal, or agreed on in an agreement.

Referring to FIG. 5b, an embodiment of this application provides a channel sharing apparatus 510. The apparatus may be applied to the second terminal in the foregoing method description, and includes:
a receiving module 511, configured to: receive COT sharing information from a first terminal, where the COT sharing information is used for indicating shared COT; and
a processing module 512, configured to process the COT sharing information.

In a possible implementation, the COT sharing information includes one or more of the following:
first information, used for indicating a cast type for the shared COT;
second information, used for indicating an identifier of the first terminal;
third information, used for indicating an identifier of the second terminal, or indicating an identifier of a terminal group including the second terminal;
fourth information, used for indicating an identifier of a third terminal, or indicating an identifier of a terminal group including the third terminal, where the identifier of the third terminal or the identifier of the terminal group including the third terminal is used for allowing the second terminal to use the shared COT to transmit data to the third terminal;
fifth information, used for indicating whether the second terminal is allowed to share the shared COT with another terminal;
sixth information, used for indicating whether the second terminal is allowed to use the shared COT to transmit data, a control signaling, a group-cast message, and/or a broadcast message to another terminal except the first terminal;
seventh information, used for indicating whether the shared COT is used for transmitting a PSFCH message;
eighth information, used for indicating time-domain resource information of the shared COT and/or frequency-domain resource information of the shared COT;
ninth information, used for indicating a resource shared by the first terminal with the second terminal;
tenth information, used for indicating a resource pool shared by the first terminal with the second terminal;
eleventh information, used for indicating a BWP configuration shared by the first terminal with the second terminal;
twelfth information, used for indicating an identifier of a terminal that uses the shared COT;
thirteenth information, used for indicating, in a unit of slot, time-domain offset between a start time-domain position of the shared COT and a time-domain position where the COT sharing information is located;
fourteenth information, used for indicating, in unit of symbol, a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located;
fifteenth information, used for indicating a duration of the shared COT in unit of slot;
sixteenth information, used for indicating a duration of the shared COT in unit of symbol, or indicating the duration of the shared COT jointly with the fifteenth information; and
seventeenth information, used for indicating a CAPC value.

In a possible implementation, the COT sharing information satisfies one or more of the following:
in a case that the COT sharing information does not include the fourth information, the COT sharing information instructs to allow the second terminal to use the shared COT to transmit the data to the first terminal, or the COT sharing information instructs to allow the second terminal to use the shared COT to transmit the control signaling or broadcast data to a destination terminal, where the destination terminal includes the first terminal; and
in a case that the COT sharing information includes the fourth information, and a value of the fourth information is a default value, the fourth information is used for instructing to allow the second terminal to use the shared COT to transmit the data to any terminal.

In a possible implementation, the apparatus further includes: a second transmitting module, configured to perform one or more of the following:
transmitting a CAPC demand value to the first terminal;
transmitting a QoS Profile to the first terminal; and
receiving a CAPC demand value request from the first terminal, and transmitting a CAPC demand value to the first terminal.

In a possible implementation, the apparatus further includes: a third transmitting module, configured to perform one or more of the following:
transmitting a PDB demand value or a remaining PDB demand value to the first terminal;
transmitting a QoS Profile to the first terminal; and
receiving a PDB demand value request or a remaining PDB demand value request from the first terminal, and transmitting a PDB demand value or a remaining PDB demand value to the first terminal.

In a possible implementation, the processing module is configured to:
use, by the second terminal, the shared COT in a case that a third condition is satisfied.

The third condition includes one or more of the following:
the second terminal transmits a PSFCH message to the first terminal;
a priority corresponding to a CAPC value of data to be transmitted of the second terminal is higher than or equal to a priority corresponding to a CAPC value indicated in the COT sharing information;
a group-cast destination identifier of a group-cast service transmitted by the second terminal using the shared COT is a group-cast destination identifier that the first terminal expects to receive;
an identifier of the second terminal is the same as an identifier, indicated in the COT sharing information, of a terminal that uses the shared COT; and
an identifier of the second terminal is included in an identifier, indicated in the COT sharing information, of a terminal that uses the shared COT.

In a possible implementation, the group-cast destination identifier that the first terminal expects to receive is an identifier indicated by the third information or an identifier indicated by the fourth information;
or,
the group-cast destination identifier that the first terminal expects to receive is a destination identifier indicated by destination sidelink control information (SCI) and/or indicated by a destination medium access control control element (MAC CE), where the destination SCI is SCI that is received by the second terminal from the first terminal and carries the COT sharing information, and the destination MAC CE is an MAC CE that is received by the second terminal from the first terminal and carries the COT sharing information.

In a possible implementation, the processing module is configured to:
trigger one or more of resource selection, resource reselection, resource selection check, and reselection check according to the COT sharing information.

In a possible implementation, the processing module is configured to:
transmit a first indication from a physical layer of the second terminal to a medium access control (MAC) layer of the second terminal according to the COT sharing information;
instruct, by the MAC layer of the second terminal according to the first indication, the physical layer of the second terminal to trigger resource selection or resource reselection; and
perform, by the physical layer of the second terminal, a first operation.

The first indication includes one or more of the following:
first indication information, used for indicating that the second terminal has received the COT sharing information;
second indication information, used for indicating that the second terminal has received the shared COT; and
third indication information, used for instructing the MAC layer of the second terminal to trigger resource selection check or resource reselection check.

The first operation includes one or more of the following:
performing a resource selection procedure or a resource reselection procedure to form a selectable resource set, and informing the MAC layer of the second terminal of the selectable resource set; and
performing the resource selection or resource reselection according to a resource indicated by the COT sharing information.

The channel sharing apparatus in this embodiment of this application may be an electronic device, for example, an electronic device having an operating system, or a component in an electronic device, such as an integrated circuit or a chip. The electronic device may be a terminal or another device except a terminal. Exemplarily, the terminal may include, but is not limited to, the types of the terminal 11 listed above, and the other device may be a server, a network attached storage (NAS), or the like. The embodiments of this application do not impose a specific limitation on this.

The channel sharing apparatus provided in this embodiment of this application can implement the various processes implemented by the method embodiment shown in FIG. 2 to FIG. 3b and achieve the same technical effects, details of which are omitted here for brevity.

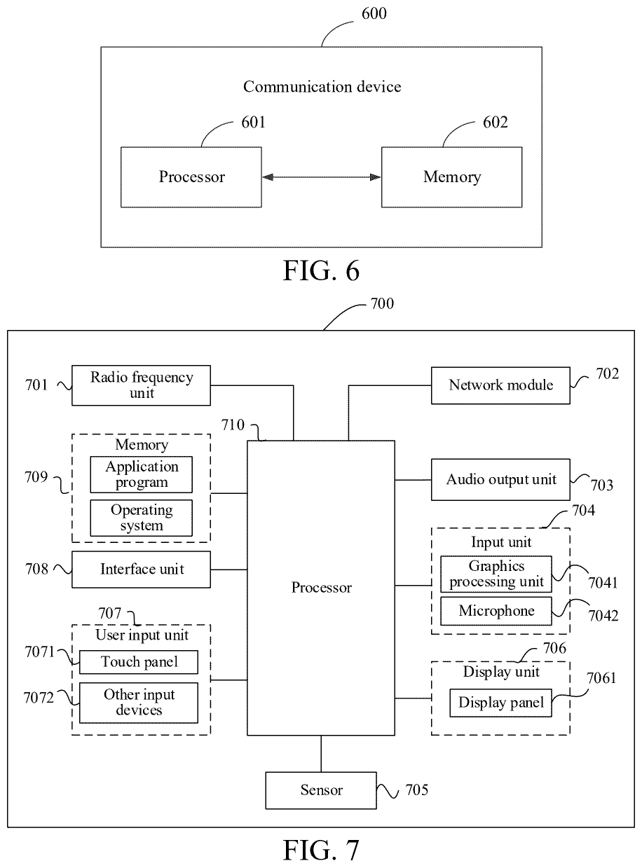

In some embodiments, as shown in FIG. 6, an embodiment of this application further provides a communication device 600, including a processor 601 and a memory 602. The memory 602 has a program or an instruction runnable on the processor 601. For example, when the communication device 600 is a terminal, the program or instruction, when run by the processor 601, implements the various steps of the above channel sharing method embodiments and can achieve the same technical effects. When the communication device 600 is a network side device, the program or instruction, when run by the processor 601, implements the various steps of the above channel sharing method embodiments and can achieve the same technical effects, details of which are omitted here for brevity.

An embodiment of this application further provides a terminal, including a processor and a communication interface. The processor is configured to determine COT sharing information. The COT sharing information is used for indicating shared COT. The communication interface is used for transmitting the COT sharing information to one or more second terminals.

Or, the communication interface is used for receiving COT sharing information from a first terminal. The COT sharing information is used for indicating shared COT. The processor is configured to process the COT sharing information.

The terminal embodiment corresponds to the terminal side method embodiment described above. The various implementation processes and implementations of the above method embodiment can be applied to the terminal embodiment and can achieve the same technical effects. In some embodiments, FIG. 7 is a schematic structural diagram of hardware of a terminal for implementing the embodiments of this application.

The terminal 700 includes, but is not limited to: at least some of a radio frequency unit 701, a network module 702, an audio output unit 703, an input unit 704, a sensor 705, a display unit 706, a user input unit 707, an interface unit 708, a memory 709, a processor 710, and the like.

Those skilled in the art can understand that the terminal 700 further includes a power supply (such as a battery) for supplying power to the various components. The power supply may be logically connected to the processor 710 by using a power management system, thereby implementing functions such as charging, discharging, and power consumption management by using the power management system. The structures of the terminal shown in FIG. 7 constitute no limitation on the terminal, and the terminal may include more or fewer components than those shown in the figure, or some components may be combined, or a different component deployment may be used, details of which are omitted here.

It should be understood that in this embodiment of this application, the input unit 704 may include a graphics processing unit (GPU) 7041 and a microphone 7042, and the GPU 7041 processes image data of static pictures or videos obtained by an image capturing apparatus (such as a camera) in a video capturing mode or an image capturing mode. The display unit 706 may include a display panel 7061, and the display panel 7061 may be configured by using a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include, but not limited to, a physical keyboard, a function key (such as a volume control key or a switch key), a track ball, a mouse, and a joystick, which is not described herein again.

In this embodiment of this application, the radio frequency unit 701 receives downlink data from a network side device and can transmit the data to the processor 710 for processing. In addition, the radio frequency unit 701 may transmit uplink data to the network side device. Generally, the radio frequency unit 701 includes, but is not limited to, an antenna, an amplifier, a transceiver, a coupler, a low noise amplifier, a duplexer, and the like.

The memory 709 may be configured to store a software program or an instruction and various data. The memory 709 may mainly include a first storage area for storing a program or instructions, and a second storage area for storing data. The first storage area may store an operating system, an application program or instructions required by at least one function (for example, a sound playing function and an image display function), and the like. The memory 709 may be a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes these and any other suitable types of memories.

The processor 710 may include one or more processing units. In some embodiments, the processor 710 may integrate an application processor and a modem processor, where the application processor mainly processes operations involving an operating system, a user interface, an application program, and the like, and the modem processor mainly processes a wireless communication signal, such as a baseband processor. It can be understood that, the modem processor may not be integrated into the processor 710.

For a case where the terminal 700 is the first terminal in the method description:
the processor 710 is configured to determine COT sharing information, where the COT sharing information is used for indicating shared COT; and
a radio frequency unit 701 is configured to transmit the COT sharing information to one or more second terminals.

In a possible implementation, the COT sharing information includes one or more of the following:
first information, used for indicating a cast type for the shared COT;
second information, used for indicating an identifier of the first terminal;
third information, used for indicating an identifier of the second terminal, or indicating an identifier of a terminal group including the second terminal;
fourth information, used for indicating an identifier of a third terminal, or indicating an identifier of a terminal group including the third terminal, where the identifier of the third terminal or the identifier of the terminal group including the third terminal is used for allowing the second terminal to use the shared COT to transmit data to the third terminal;
fifth information, used for indicating whether the second terminal is allowed to share the shared COT with another terminal;
sixth information, used for indicating whether the second terminal is allowed to use the shared COT to transmit data, a control signaling, a group-cast message, and/or a broadcast message to another terminal except the first terminal;
seventh information, used for indicating whether the shared COT is used for transmitting a PSFCH message;
eighth information, used for indicating time-domain resource information of the shared COT and/or frequency-domain resource information of the shared COT;
ninth information, used for indicating a resource shared by the first terminal with the second terminal;
tenth information, used for indicating a resource pool shared by the first terminal with the second terminal;
eleventh information, used for indicating a bandwidth part (BWP) configuration shared by the first terminal with the second terminal;
twelfth information, used for indicating an identifier of a terminal that uses the shared COT;
thirteenth information, used for indicating, in unit of slot, a time-domain offset between a start time-domain position of the shared COT and a time-domain position at which the COT sharing information is located;
fourteenth information, used for indicating, in unit of symbol, a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located;
fifteenth information, used for indicating a duration of the shared COT in unit of slot;
sixteenth information, used for indicating a duration of the shared COT in unit of symbol, or indicating the duration of the shared COT jointly with the fifteenth information; and
seventeenth information, used for indicating a CAPC value.

In a possible implementation, the COT sharing information satisfies one or more of the following:
in a case that the COT sharing information does not include the fourth information, the COT sharing information instructs to allow the second terminal to use the shared COT to transmit the data to the first terminal, or the COT sharing information instructs to allow the second terminal to use the shared COT to transmit the control signaling or broadcast data to a destination terminal, where the destination terminal includes the first terminal; and
in a case that the COT sharing information includes the fourth information, and a value of the fourth information is a default value, the fourth information is used for instructing to allow the second terminal to use the shared COT to transmit the data to any terminal.

In a possible implementation, the processor 710 is configured to determine, before transmitting the COT sharing information to the one or more second terminals, a destination CAPC value used for an LBT operation through any one of the following:
the first terminal obtains CAPC demand values of the one or more second terminals, and determines the destination CAPC value according to a CAPC demand value with the lowest corresponding priority among the CAPC demand values of the one or more second terminals;
the first terminal obtains CAPC demand values of the one or more second terminals, and determines the destination CAPC value according to a CAPC demand value with the highest corresponding priority among the CAPC demand values of the one or more second terminals;
the first terminal obtains packet delay budget (PDB) demand values or remaining PDB demand values of data to be transmitted of the one or more second terminals, and determines the destination CAPC value according to the PDB demand values or the remaining PDB demand values of the data to be transmitted of the one or more second terminals; and
the first terminal determines the destination CAPC value according to a time-domain position at which the one or more second terminals transmit PSFCH message(s).

In a possible implementation, the processor 710 is configured to perform one or more of the following:
receiving, by the first terminal, the CAPC demand values from the one or more second terminals;
receiving, by the first terminal, QoS Profile from the one or more second terminals, and determining the CAPC demand values of the one or more second terminals according to CAPC values with the highest or lowest corresponding priorities among CAPC values associated with the QOS Profiles of the one or more second terminals;
determining, by the first terminal, the CAPC demand values of the one or more second terminals according to CAPC values with the highest or lowest corresponding priorities among CAPC values associated with QoS Flow transmitted between the first terminal and the one or more second terminals; and
transmitting, by the first terminal, a CAPC demand value request to the one or more second terminals, and receiving the CAPC demand values from the one or more second terminals.

In a possible implementation, the processor 710 is configured to perform one or more of the following:
receiving, by the first terminal, the PDB demand values or the remaining PDB demand values from the one or more second terminals;
receiving, by the first terminal, QoS Profiles from the one or more second terminals, and determining the PDB demand values or the remaining PDB demand values of the one or more second terminals according to PDB demand values or remaining PDB demand values associated with the QoS Profiles of the one or more second terminals;
determining, by the first terminal, the PDB demand values or the remaining PDB demand values of the one or more second terminals according to PDB demand values or remaining PDB demand values associated with QoS Flows transmitted between the first terminal and the one or more second terminals; and
transmitting, by the first terminal, a PDB demand value request or a remaining PDB demand value request to the one or more second terminals, and receiving the PDB demand values or the remaining PDB demand values from the one or more second terminals.

In a possible implementation, the processor 710 is configured to:
separately determine, by the first terminal, one or more target CAPC values according to the time-domain position at which each of the one or more second terminals transmits the PSFCH message;
or,
determine, by the first terminal, one destination CAPC value jointly based on time-domain positions at which PSFCH messages are transmitted by all the second terminals among the one or more second terminals.

In a possible implementation, the processor 710 is configured to determine, before determining the COT sharing information, a second terminal satisfying a first condition to be a destination receiving object of the COT sharing information.

The first condition includes one or more of the following:
the highest priority among priorities corresponding to one or more CAPC demand values of the second terminal is lower than or equal to a first priority; and
the highest priority among the priorities corresponding to the one or more CAPC demand values of the second terminal is lower than or equal to a second priority.

The first priority is a priority corresponding to a CAPC value used by the first terminal for determining the shared COT, and the second priority is lower than or equal to the first priority.

In a possible implementation, the processor 710 is configured to:
determine the COT sharing information in a case that a second condition is satisfied.

The second condition includes any one of the following:
a cache of the first terminal has data to be transmitted to a first destination object, and a CAPC priority or an SL logical channel priority corresponding to the data to be transmitted is higher than or equal to a first threshold, where the first destination object is an SL peer terminal or a group-cast object of the first terminal;
a cache of the first terminal has data to be transmitted to a first destination object, and a CAPC priority or an SL logical channel priority corresponding to the data to be transmitted is less than or equal to a second threshold, where the first destination object is an SL peer terminal or a group-cast object of the first terminal; and
an energy detection result or a reference signal received power (RSRP) measurement result of LBT performed by the first terminal is less than or equal to a third threshold.

The first threshold, the second threshold, and the third threshold are configured by a network, configured by another terminal, or agreed on in an agreement.

For a case where the terminal 700 is the second terminal in the method description:
the radio frequency unit 701 is configured to: receive COT sharing information from a first terminal, where the COT sharing information is used for indicating shared COT; and
the processor 710 is configured to process the COT sharing information.

In a possible implementation, the COT sharing information includes one or more of the following:
first information, used for indicating a cast type for the shared COT;
second information, used for indicating an identifier of the first terminal;
third information, used for indicating an identifier of the second terminal, or indicating an identifier of a terminal group including the second terminal;
fourth information, used for indicating an identifier of a third terminal, or indicating an identifier of a terminal group including the third terminal, where the identifier of the third terminal or the identifier of the terminal group including the third terminal is used for allowing the second terminal to use the shared COT to transmit data to the third terminal;
fifth information, used for indicating whether the second terminal is allowed to share the shared COT with another terminal;
sixth information, used for indicating whether the second terminal is allowed to use the shared COT to transmit data, a control signaling, a group-cast message, and/or a broadcast message to another terminal except the first terminal;
seventh information, used for indicating whether the shared COT is used for transmitting a PSFCH message;
eighth information, used for indicating time-domain resource information of the shared COT and/or frequency-domain resource information of the shared COT;
ninth information, used for indicating a resource shared by the first terminal with the second terminal;
tenth information, used for indicating a resource pool shared by the first terminal with the second terminal;
eleventh information, used for indicating a BWP configuration shared by the first terminal with the second terminal;
twelfth information, used for indicating an identifier of a terminal that uses the shared COT;
thirteenth information, used for indicating, in a unit of slot, time-domain offset between a start time-domain position of the shared COT and a time-domain position where the COT sharing information is located;
fourteenth information, used for indicating, in unit of symbol, a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located;
fifteenth information, used for indicating a duration of the shared COT in unit of slot;
sixteenth information, used for indicating a duration of the shared COT in unit of symbol, or indicating the duration of the shared COT jointly with the fifteenth information; and
seventeenth information, used for indicating a CAPC value.

In a possible implementation, the COT sharing information satisfies one or more of the following:
in a case that the COT sharing information does not include the fourth information, the COT sharing information instructs to allow the second terminal to use the shared COT to transmit the data to the first terminal, or the COT sharing information instructs to allow the second terminal to use the shared COT to transmit the control signaling or broadcast data to a destination terminal, where the destination terminal includes the first terminal; and
in a case that the COT sharing information includes the fourth information, and a value of the fourth information is a default value, the fourth information is used for instructing to allow the second terminal to use the shared COT to transmit the data to any terminal.

In a possible implementation, the radio frequency unit 701 is configured to perform one or more of the following:
transmitting a CAPC demand value to the first terminal;
transmitting a QoS Profile to the first terminal; and
receiving a CAPC demand value request from the first terminal, and transmitting a CAPC demand value to the first terminal.

In a possible implementation, the radio frequency unit 701 is configured to perform one or more of the following:
transmitting a PDB demand value or a remaining PDB demand value to the first terminal;
transmitting a QoS Profile to the first terminal; and
receiving a PDB demand value request or a remaining PDB demand value request from the first terminal, and transmitting a PDB demand value or a remaining PDB demand value to the first terminal.

In a possible implementation, the processor 710 is configured to:
use, by the second terminal, the shared COT in a case that a third condition is satisfied.

The third condition includes one or more of the following:
the second terminal transmits a PSFCH message to the first terminal;
a priority corresponding to a CAPC value of data to be transmitted of the second terminal is higher than or equal to a priority corresponding to a CAPC value indicated in the COT sharing information;
a group-cast destination identifier of a group-cast service transmitted by the second terminal using the shared COT is a group-cast destination identifier that the first terminal expects to receive;
an identifier of the second terminal is the same as an identifier, indicated in the COT sharing information, of a terminal that uses the shared COT; and
an identifier of the second terminal is included in an identifier, indicated in the COT sharing information, of a terminal that uses the shared COT.

In a possible implementation, the group-cast destination identifier that the first terminal expects to receive is an identifier indicated by the third information or an identifier indicated by the fourth information;
or,
the group-cast destination identifier that the first terminal expects to receive is a destination identifier indicated by destination sidelink control information (SCI) and/or indicated by a destination medium access control control element (MAC CE), where the destination SCI is SCI that is received by the second terminal from the first terminal and carries the COT sharing information, and the destination MAC CE is an MAC CE that is received by the second terminal from the first terminal and carries the COT sharing information.

In a possible implementation, the processor 710 is configured to:
trigger one or more of resource selection, resource reselection, resource selection check, and reselection check according to the COT sharing information.

In a possible implementation, the processor 710 is configured to:
transmit a first indication from a physical layer of the second terminal to a medium access control (MAC) layer of the second terminal according to the COT sharing information;
instruct, by the MAC layer of the second terminal according to the first indication, the physical layer of the second terminal to trigger resource selection or resource reselection; and
perform, by the physical layer of the second terminal, a first operation.

The first indication includes one or more of the following:
first indication information, used for indicating that the second terminal has received the COT sharing information;
second indication information, used for indicating that the second terminal has received the shared COT; and
third indication information, used for instructing the MAC layer of the second terminal to trigger resource selection check or resource reselection check.

The first operation includes one or more of the following:
performing a resource selection procedure or a resource reselection procedure to form a selectable resource set, and informing the MAC layer of the second terminal of the selectable resource set; and
performing the resource selection or resource reselection according to a resource indicated by the COT sharing information.

An embodiment of this application further provides a readable storage medium. The readable storage medium stores a program or an instruction. The program or instruction, when run by a processor, implements the various processes of the foregoing channel sharing method embodiment and can achieve the same technical effects, details of which are omitted here for brevity.

The processor is the processor in the terminal in the embodiments described above. The readable storage medium includes a computer-readable storage medium, for example, a computer ROM, a RAM, a magnetic disc, a compact disc, or the like.

An embodiment of this application further provides a chip. The chip includes a processor and a communication interface. The communication interface is coupled to the processor. The processor is configured to run or execute a program or an instruction to implement the various processes of the channel sharing method embodiment and can achieve the same technical effects, details of which are omitted here for brevity. It should be understood that the chip mentioned in some embodiments of this application can be referred to as a system chip, a chip system, or a system-on-chip.

An embodiment of this application further provides a computer program/program product. The computer program/program product is stored in a storage medium. The computer program/program product, when run by at least one processor, implements the various processes of the foregoing channel sharing method embodiment and can achieve the same technical effects, details of which are omitted here for brevity.

An embodiment of this application further provides a channel sharing system, an architecture of which can be found in FIG. 1. The system includes: a first terminal and a second terminal, corresponding to a terminal 11 in FIG. 1. The first terminal, as a transmitting-side terminal, may be configured to perform the steps of the channel sharing method shown in FIG. 2. The second terminal, as a receiving-side terminal, may be configured to perform the steps of the channel sharing method shown in FIG. 4.

It should be noted that, the terms “include”, “comprise”, or any other variations thereof herein are intended to cover a non-exclusive inclusion, so that a processor, method, object, or apparatus including a series of elements not only includes those elements, but also includes other elements not specifically listed, or includes inherent elements of this process, method, object, or apparatus. Without more limitations, elements defined by the sentence “including one” does not exclude that there are still other same elements in the process, method, object, or apparatus including these elements. In addition, it should be noted that the scope of the methods and devices in this embodiment of this application is not limited to executing functions in the order shown or discussed, but may alternatively include executing functions in a substantially simultaneous manner or in an opposite order according to the functions involved. For example, the methods described may be executed in a different order than that described, and various steps may alternatively be added, omitted, or combined. In addition, features described with reference to some examples may alternatively be combined in other examples.

According to the descriptions in the foregoing implementations, a person skilled in the art may clearly learn that the method according to the foregoing embodiment may be implemented by relying on software and an essential commodity hardware platform or by using hardware, but the former is a better implementation in most cases. Based on such an understanding, the technical solutions of this application essentially, or the part contributing to the prior art, may be presented in the form of a computer software product. The computer software product is stored in a storage medium (for example, a ROM/RAM, a magnetic disc, or a compact disc) including several instructions to enable a terminal (which may be a mobile phone, a computer, a server, an air conditioner, a network device, or the like) to perform the methods described in all the embodiments of this application.

The embodiments of this application have been described above with reference to the accompanying drawings. This application is not limited to the specific implementations described above, and the specific implementations described above are merely examples and not limitative. Those of ordinary skill in the art may make various forms under the teaching of this application without departing from the spirit of this application and the protection scope of the claims, and these forms shall all fall within the protection of this application.

What is claimed is:

1. A channel sharing method, comprising:
determining, by a first terminal, channel occupancy time (COT) sharing information, wherein the COT sharing information is used for indicating shared COT; and
transmitting, by the first terminal, the COT sharing information to one or more second terminals.

2. The method according to claim 1, wherein the COT sharing information comprises one or more of the following:
first information, used for indicating a cast type for the shared COT;
second information, used for indicating an identifier of the first terminal;
third information, used for indicating an identifier of the second terminal, or used for indicating an identifier of a terminal group comprising the second terminal;
fourth information, used for indicating an identifier of a third terminal, or used for indicating an identifier of a terminal group comprising the third terminal, wherein the identifier of the third terminal or the identifier of the terminal group comprising the third terminal is used for allowing the second terminal to use the shared COT to transmit data to the third terminal;
fifth information, used for indicating whether the second terminal is allowed to share the shared COT with another terminal;
sixth information, used for indicating whether the second terminal is allowed to use the shared COT to transmit data, a control signaling, a group-cast message, or a broadcast message to another terminal except the first terminal;
seventh information, used for indicating whether the shared COT is used for transmitting a physical sidelink feedback channel (PSFCH) message;
eighth information, used for indicating time-domain resource information of the shared COT or frequency-domain resource information of the shared COT;
ninth information, used for indicating a resource shared by the first terminal with the second terminal;
tenth information, used for indicating a resource pool shared by the first terminal with the second terminal;
eleventh information, used for indicating a bandwidth part (BWP) configuration shared by the first terminal with the second terminal;
twelfth information, used for indicating an identifier of a terminal that uses the shared COT;
thirteenth information, used for indicating, in unit of slot, a time-domain offset between a start time-domain position of the shared COT and a time-domain position at which the COT sharing information is located;
fourteenth information, used for indicating, in unit of symbol, a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located;
fifteenth information, used for indicating a duration of the shared COT in unit of slot;
sixteenth information, used for indicating a duration of the shared COT in unit of symbol, or used for indicating the duration of the shared COT jointly with the fifteenth information; or
seventeenth information, used for indicating a channel access priority class (CAPC) value.

3. The method according to claim 2, wherein the COT sharing information satisfies one or more of the following:
when the COT sharing information does not comprise the fourth information, the COT sharing information instructs to allow the second terminal to use the shared COT to transmit the data to the first terminal, or the COT sharing information instructs to allow the second terminal to use the shared COT to transmit the control signaling or broadcast data to a destination terminal, wherein the destination terminal comprises the first terminal; or
when the COT sharing information comprises the fourth information, and a value of the fourth information is a default value, the fourth information is used for instructing to allow the second terminal to use the shared COT to transmit the data to any terminal.

4. The method according to claim 1, wherein before the transmitting, by the first terminal, the COT sharing information to one or more second terminals, the method further comprises:
determining, by the first terminal by using any one of the following, a destination CAPC value used for a listen before talk (LBT) operation:
obtaining, by the first terminal, CAPC demand values of the one or more second terminals, and determining the destination CAPC value according to a CAPC demand value with the lowest corresponding priority among the CAPC demand values of the one or more second terminals;
obtaining, by the first terminal, CAPC demand values of the one or more second terminals, and determining the destination CAPC value according to a CAPC demand value with the highest corresponding priority among the CAPC demand values of the one or more second terminals;
obtaining, by the first terminal, packet delay budget (PDB) demand values or remaining PDB demand values of data to be transmitted by the one or more second terminals, and determining the destination CAPC value according to the PDB demand values or the remaining PDB demand values of the data to be transmitted by the one or more second terminals; and
determining, by the first terminal, the destination CAPC value according to a time-domain position at which the one or more second terminals transmit PSFCH message(s).

5. The method according to claim 4, wherein the obtaining, by the first terminal, the CAPC demand values of the one or more second terminals comprises one or more of the following:
receiving, by the first terminal, the CAPC demand values from the one or more second terminals;
receiving, by the first terminal, quality of service (QOS) Profiles from the one or more second terminals, and determining the CAPC demand values of the one or more second terminals according to CAPC values with the highest or lowest corresponding priorities among CAPC values associated with the QoS Profiles of the one or more second terminals;
determining, by the first terminal, the CAPC demand values of the one or more second terminals according to CAPC values with the highest or lowest corresponding priorities among CAPC values associated with quality of service (QOS) Flows transmitted between the first terminal and the one or more second terminals; or
transmitting, by the first terminal, a CAPC demand value request to the one or more second terminals, and receiving the CAPC demand values from the one or more second terminals.

6. The method according to claim 4, wherein the obtaining, by the first terminal, the PDB demand values or remaining PDB demand values of data to be transmitted by the one or more second terminals comprises one or more of the following:
receiving, by the first terminal, the PDB demand values or the remaining PDB demand values from the one or more second terminals;
receiving, by the first terminal, QoS Profiles from the one or more second terminals, and determining the PDB demand values or the remaining PDB demand values of the one or more second terminals according to PDB demand values or remaining PDB demand values associated with the QoS Profiles of the one or more second terminals;
determining, by the first terminal, the PDB demand values or the remaining PDB demand values of the one or more second terminals according to PDB demand values or remaining PDB demand values associated with QoS Flows transmitted between the first terminal and the one or more second terminals; or
transmitting, by the first terminal, a PDB demand value request or a remaining PDB demand value request to the one or more second terminals, and receiving the PDB demand values or the remaining PDB demand values from the one or more second terminals.

7. The method according to claim 4, wherein the determining, by the first terminal, the destination CAPC value according to a time-domain position at which the one or more second terminals transmit PSFCH message(s) comprises:
separately determining, by the first terminal, one or more destination CAPC values according to the time-domain position at which each of the one or more second terminals transmits the PSFCH message; or
determining, by the first terminal, one destination CAPC value jointly according to the time-domain position at which all the second terminals among the one or more second terminals transmit the PSFCH messages.

8. The method according to claim 1, wherein before the determining, by the first terminal, the COT sharing information, the method further comprises:
determining, by the first terminal, a second terminal satisfying a first condition to be a destination receiving object of the COT sharing information,
wherein the first condition comprises one or more of the following:
the highest priority among priorities corresponding to one or more CAPC demand values of the second terminal is lower than or equal to a first priority; or
the highest priority among the priorities corresponding to the one or more CAPC demand values of the second terminal is lower than or equal to a second priority, and
wherein the first priority is a priority corresponding to a CAPC value used by the first terminal for determining the shared COT, and the second priority is lower than or equal to the first priority.

9. The method according to claim 1, wherein the determining, by the first terminal, the COT sharing information comprises:
determining, by the first terminal, the COT sharing information when a second condition is satisfied;
wherein the second condition comprises any one of the following:
a cache of the first terminal has data to be transmitted to a first destination object, and a CAPC priority or an SL logical channel priority corresponding to the data to be transmitted is higher than or equal to a first threshold, wherein the first destination object is a sidelink (SL) peer terminal or a group-cast object of the first terminal;
a cache of the first terminal has data to be transmitted to a first destination object, and a CAPC priority or an SL logical channel priority corresponding to the data to be transmitted is less than or equal to a second threshold, wherein the first destination object is an SL peer terminal or a group-cast object of the first terminal; or
an energy detection result or a reference signal received power (RSRP) measurement result of LBT performed by the first terminal is less than or equal to a third threshold.

10. A channel sharing method, comprising:
receiving, by a second terminal, channel occupancy time (COT) sharing information from a first terminal, wherein the COT sharing information is used for indicating shared COT; and
processing, by the second terminal, the COT sharing information.

11. The method according to claim 10, wherein the COT sharing information comprises one or more of the following:
first information, used for indicating a cast type for the shared COT;
second information, used for indicating an identifier of the first terminal;
third information, used for indicating an identifier of the second terminal or an identifier of a terminal group comprising the second terminal;
fourth information, used for indicating an identifier of a third terminal or an identifier of a terminal group comprising the third terminal, wherein the identifier of the third terminal or the identifier of the terminal group comprising the third terminal is used for allowing the second terminal to use the shared COT to transmit data to the third terminal;
fifth information, used for indicating whether the second terminal is allowed to share the shared COT with another terminal;
sixth information, used for indicating whether the second terminal is allowed to use the shared COT to transmit data, a control signaling, a group-cast message, or a broadcast message to another terminal except the first terminal;
seventh information, used for indicating whether the shared COT is used for transmitting a physical sidelink feedback channel (PSFCH) message;
eighth information, used for indicating time-domain resource information of the shared COT or frequency-domain resource information of the shared COT;
ninth information, used for indicating a resource shared by the first terminal with the second terminal;
tenth information, used for indicating a resource pool shared by the first terminal with the second terminal;
eleventh information, used for indicating a bandwidth part (BWP) configuration shared by the first terminal with the second terminal;
twelfth information, used for indicating an identifier of a terminal that uses the shared COT;
thirteenth information, used for indicating, in a unit of slot, time-domain offset between a start time-domain position of the shared COT and a time-domain position where the COT sharing information is located;
fourteenth information, used for indicating, in unit of symbol, a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located;
fifteenth information, used for indicating a duration of the shared COT in unit of slot;
sixteenth information, used for indicating a duration of the shared COT in unit of symbol, or used for indicating the duration of the shared COT jointly with the fifteenth information; or
seventeenth information, used for indicating a channel access priority class (CAPC) value.

12. The method according to claim 11, wherein the COT sharing information satisfies one or more of the following:
when the COT sharing information does not comprise the fourth information, the COT sharing information instructs to allow the second terminal to use the shared COT to transmit the data to the first terminal, or the COT sharing information instructs to allow the second terminal to use the shared COT to transmit the control signaling or broadcast data to a destination terminal, wherein the destination terminal comprises the first terminal; or
when the COT sharing information comprises the fourth information, and a value of the fourth information is a default value, the fourth information is used for instructing to allow the second terminal to use the shared COT to transmit the data to any terminal.

13. The method according to claim 10, further comprising one or more of the following:
transmitting, by the second terminal, a CAPC demand value to the first terminal;
transmitting, by the second terminal, a QoS Profile to the first terminal; or
receiving, by the second terminal, a CAPC demand value request from the first terminal, and transmitting a CAPC demand value to the first terminal.

14. The method according to claim 10, further comprising one or more of the following:
transmitting, by the second terminal, a packet delay budget (PDB) demand value or a remaining PDB demand value to the first terminal;
transmitting, by the second terminal, a QoS Profile to the first terminal; or
receiving, by the second terminal, a PDB demand value request or a remaining PDB demand value request from the first terminal, and transmitting a PDB demand value or a remaining PDB demand value to the first terminal.

15. The method according to claim 11, wherein the processing, by the second terminal, the COT sharing information comprises:
using, by the second terminal, the shared COT when a third condition is satisfied;
wherein the third condition comprises one or more of the following:
the second terminal transmits a PSFCH message to the first terminal;
a priority corresponding to a CAPC value of data to be transmitted by the second terminal is higher than or equal to a priority corresponding to a CAPC value indicated in the COT sharing information;
a group-cast destination identifier of a group-cast service transmitted by the second terminal using the shared COT is a group-cast destination identifier that the first terminal expects to receive;
an identifier of the second terminal is the same as an identifier, indicated in the COT sharing information, of a terminal that uses the shared COT; or
an identifier of the second terminal is included in an identifier, indicated in the COT sharing information, of a terminal that uses the shared COT.

16. The method according to claim 15, wherein
the group-cast destination identifier that the first terminal expects to receive is an identifier indicated by the third information or an identifier indicated by the fourth information; or,
the group-cast destination identifier that the first terminal expects to receive is a destination identifier indicated by destination sidelink control information (SCI) or indicated by a destination medium access control control element (MAC CE), wherein the destination SCI is SCI that is received by the second terminal from the first terminal and carries the COT sharing information, and the destination MAC CE is an MAC CE that is received by the second terminal from the first terminal and carries the COT sharing information.

17. The method according to claim 10, wherein the processing, by the second terminal, the COT sharing information comprises:
triggering, by the second terminal, one or more of resource selection, resource reselection, resource selection check, or reselection check according to the COT sharing information.

18. The method according to claim 10, wherein the processing, by the second terminal, the COT sharing information comprises:
transmitting, by the second terminal, a first indication from a physical layer of the second terminal to a medium access control (MAC) layer of the second terminal according to the COT sharing information;
instructing, by the MAC layer of the second terminal according to the first indication, the physical layer of the second terminal to trigger resource selection or resource reselection; and
performing, by the physical layer of the second terminal, a first operation,
wherein the first indication comprises one or more of the following:
first indication information, used for indicating that the second terminal has received the COT sharing information;
second indication information, used for indicating that the second terminal has received the shared COT; or
third indication information, used for instructing the MAC layer of the second terminal to trigger resource selection check or resource reselection check,
the first operation comprises one or more of the following:
performing a resource selection procedure or a resource reselection procedure to form a selectable resource set, and informing the MAC layer of the second terminal of the selectable resource set; or
performing the resource selection or resource reselection according to a resource indicated by the COT sharing information.

19. A terminal, comprising a processor and a memory storing instructions, wherein the instructions, when executed by the processor, cause the processor to perform operations comprising:
determining channel occupancy time (COT) sharing information, wherein the COT sharing information is used for indicating shared COT; and
transmitting the COT sharing information to one or more second terminals.

20. The terminal according to claim 19, wherein the COT sharing information comprises one or more of the following:
first information, used for indicating a cast type for the shared COT;
second information, used for indicating an identifier of the first terminal;
third information, used for indicating an identifier of the second terminal, or used for indicating an identifier of a terminal group comprising the second terminal;
fourth information, used for indicating an identifier of a third terminal, or used for indicating an identifier of a terminal group comprising the third terminal, wherein the identifier of the third terminal or the identifier of the terminal group comprising the third terminal is used for allowing the second terminal to use the shared COT to transmit data to the third terminal;
fifth information, used for indicating whether the second terminal is allowed to share the shared COT with another terminal;
sixth information, used for indicating whether the second terminal is allowed to use the shared COT to transmit data, a control signaling, a group-cast message, or a broadcast message to another terminal except the first terminal;
seventh information, used for indicating whether the shared COT is used for transmitting a physical sidelink feedback channel (PSFCH) message;
eighth information, used for indicating time-domain resource information of the shared COT or frequency-domain resource information of the shared COT;
ninth information, used for indicating a resource shared by the first terminal with the second terminal;
tenth information, used for indicating a resource pool shared by the first terminal with the second terminal;
eleventh information, used for indicating a bandwidth part (BWP) configuration shared by the first terminal with the second terminal;
twelfth information, used for indicating an identifier of a terminal that uses the shared COT;
thirteenth information, used for indicating, in unit of slot, a time-domain offset between a start time-domain position of the shared COT and a time-domain position at which the COT sharing information is located;
fourteenth information, used for indicating, in unit of symbol, a time-domain offset between the start time-domain position of the shared COT and the time-domain position at which the COT sharing information is located, or used for indicating, jointly with the twelfth information, the time-domain offset between the start time-domain position of the shared COT and the time-domain position at which the COT sharing information is located;
fifteenth information, used for indicating a duration of the shared COT in unit of slot;
sixteenth information, used for indicating a duration of the shared COT in unit of symbol, or used for indicating the duration of the shared COT jointly with the fifteenth information; or
seventeenth information, used for indicating a channel access priority class (CAPC) value.
